(19) United States
(12) Patent Application Publication
(10) Pub. No.: US 2018/0273266 A1
(43) Pub. Date: Sep. 27, 2018

(54) Packaging body and method of manufacturing the same, and packaging bag and use of the same

(71) Applicant: Asahi Kasei Pax Corporation, Chiyoda-ku Tokyo (JP)

(72) Inventor: Hitoshi HAGIMOTO, Tokyo (JP)

(73) Assignee: Asahi Kasei Pax Corporation, Chiyoda-ku Tokyo (JP)

(21) Appl. No.: 15/694,902

(22) Filed: Sep. 4, 2017

(30) Foreign Application Priority Data
Mar. 27, 2017 (JP) 2017-001330

(51) Int. Cl. B65D 75/30; B65D 65/40; B65D 75/26; B32B 7/12; B32B 27/08

(52) U.S. Cl. CPC B65D 75/30; B65D 65/40; B32B 27/08; B32B 7/12; B65D 75/26

(57) ABSTRACT

Provided is a packaging body having excellent pressure resistance. The packaging body includes a front surface film, a rear surface film, an adhesive layer on the front surface film, and a seal on the rear surface film. A closed section is formed at a first longitudinal direction-end side and a tightly sealed section is formed at a second longitudinal direction-end side. The tightly sealed section includes at least a layered structure I in which the front surface film, rear surface film, and adhesive layer are stacked in an order of adhesive layer/front surface film/rear surface film/rear surface film/front surface film/front surface film/rear surface film, and a layered structure II in which these films are stacked in an order of adhesive layer/rear surface film/front surface film/front surface film/rear surface film in a packaging body thickness direction. The layered structure I and layered structure II are covered by the seal.

### TECHNICAL FIELD

This disclosure relates to a packaging body, a method of manufacturing a packaging body, a packaging bag, and a use of a packaging bag.

### BACKGROUND

There are situations in which contents are placed in a bag that is then tightly sealed and transported, such as in transportation of an infectious substance or the like. From a viewpoint of versatility, there is demand for the bag used in transportation to be a bag that can be tightly sealed through a simple operation without using special equipment. One known example of such a packaging bag is a packaging bag that after contents have been placed therein through an open section, can be tightly sealed with ease at the open section by human hands, without using a special machine such as a heat sealing machine (refer to PTL 1 and PTL 2).

### CITATION LIST

### Patent Literature

PTL 1: JP H11-59696 A

PTL 2: JP 2012-6637 A

### SUMMARY

### Technical Problem

There is demand for a bag having excellent post-sealing pressure resistance for use as a packaging bag in transportation from viewpoints such as preventing contents from bursting out under low pressure during air transportation or the like, and meeting pressure resistance requirements set by transportation regulations for the transportation of infectious substances or the like.

The packaging bags described in PTL 1 and PTL 2 have inadequate post-sealing pressure resistance because contents may burst out from a tightly sealed section of the packaging bag when high internal pressure acts after tight sealing. Particularly in the case of the packaging bag described in PTL 2, in a situation in which bulky contents are placed in the packaging bag, creases tend to form when the open section of the packaging bag is sealed with a sealing member, the operation of tight sealing is not simple, and post-sealing pressure resistance is inadequate.

Accordingly, an objective of this disclosure is to provide a packaging body having excellent pressure resistance. Another objective of this disclosure is to provide a packaging bag that can be tightly sealed with ease at an open section thereof and that has excellent post-sealing pressure resistance.

### Solution to Problem

This disclosure provides the following as a solution to the problems set forth above.

[1] A packaging body comprising at least a front surface film, a rear surface film, an adhesive layer on the front surface film, and a seal on the rear surface film, wherein

the front surface film and the rear surface film are affixed to each other at both width direction-end edges and at a first longitudinal direction-end edge to form a closed section at a first longitudinal direction-end side, and part of the front surface film and part of the rear surface film are affixed to the adhesive layer to form a tightly sealed section at a second longitudinal direction-end side,

at the tightly sealed section, the packaging body includes at least a layered structure I in which the front surface film, the rear surface film, and the adhesive layer are stacked in an order of adhesive layer/front surface film/rear surface film/rear surface film/front surface film/front surface film/rear surface film in a packaging body thickness direction, and a layered structure II in which the front surface film, the rear surface film, and the adhesive layer are stacked in an order of adhesive layer/rear surface film/front surface film/front surface film/rear surface film in the packaging body thickness direction, and

the layered structure I and the layered structure II are covered by the seal.

[2] The packaging body according to the foregoing [1], wherein

the layered structure I is positioned toward the second longitudinal direction-end side relative to the layered structure II.

[3] The packaging body according to the foregoing [1] or [2], further comprising

an inner film between the front surface film and the rear surface film, wherein

the inner film is sandwiched between the front surface film and the rear surface film and is affixed to the front surface film and the rear surface film at both width direction-end edges,

the layered structure I is a layered structure stacked in an order of adhesive layer/front surface film/inner film/rear surface film/rear surface film/inner film/front surface film/front surface film/inner film/rear surface film, and

the layered structure II is a layered structure stacked in an order of adhesive layer/rear surface film/inner film/front surface film/front surface film/inner film/rear surface film.

[4] The packaging body according to any one of the foregoing [1] to [3], wherein

at the tightly sealed section, a bend portion at which the front surface film and the rear surface film are folded has a radius of curvature of 10 mm or less.

[5] The packaging body according to any one of the foregoing [1] to [4], wherein

the front surface film and the rear surface film are affixed to each other via a bottom surface film at a first longitudinal direction end.

[6] A method of manufacturing a packaging body comprising,

with respect to a packaging bag in which
a front surface film and a rear surface film are affixed to each other at both width direction-end edges and at a first longitudinal direction-end edge to form a closed section at a first longitudinal direction-end side and an open section at a second longitudinal direction-end side,
an adhesive layer of the same width as the front surface film is disposed at a packaging bag outer side of the front surface film,
a seal having an adhesive surface as at least one surface thereof is disposed at a packaging bag outer side of the rear surface film, and
one part of the adhesive surface is attached to the rear surface film and a remaining part of the adhesive surface is attached to release paper:

bending the packaging bag in a longitudinal direction and affixing an open section-side longitudinal direction end of the front surface film to a first part of the adhesive layer;

further bending the packaging bag in the longitudinal direction and affixing part of the rear surface film to a second part of the adhesive layer; and

affixing the remaining part of the adhesive surface to the front surface film such that the seal covers the first part and the second part of the adhesive layer.

[7] A use of a packaging bag comprising,

with respect to a packaging bag in which
a front surface film and a rear surface film are affixed to each other at both width direction-end edges and at a first longitudinal direction-end edge to form a closed section at a first longitudinal direction-end side and an open section at a second longitudinal direction-end side,
an adhesive layer of the same width as the front surface film is disposed at a packaging bag outer side of the front surface film,
a seal having an adhesive surface as at least one surface thereof is disposed at a packaging bag outer side of the rear surface film, and
one part of the adhesive surface is attached to the rear surface film and a remaining part of the adhesive surface is attached to release paper:

bending the packaging bag in a longitudinal direction and affixing an open section-side longitudinal direction end of the front surface film to a first part of the adhesive layer;

further bending the packaging bag in the longitudinal direction and affixing part of the rear surface film to a second part of the adhesive layer; and

affixing the remaining part of the adhesive surface to the front surface film such that the seal covers the first part and the second part of the adhesive layer.

[8] A packaging bag comprising:

a front surface film and a rear surface film that are affixed to each other at both width direction-end edges and at a first longitudinal direction-end edge to form a closed section at a first longitudinal direction-end side and an open section at a second longitudinal direction-end side;

an adhesive layer of the same width as the front surface film that is disposed at a packaging bag outer side of the front surface film; and

a seal having an adhesive surface as at least one surface thereof that is disposed at a packaging bag outer side of the rear surface film, wherein

one part of the adhesive surface is attached to the rear surface film and a remaining part of the adhesive surface is attached to release paper, and

when a longitudinal direction length of the adhesive layer is taken to be “a” and a longitudinal direction length from an open section-side longitudinal direction end of the front surface film to a closed section-side longitudinal direction end of the adhesive layer is taken to be “b”:
an inner longitudinal direction end of the one part of the adhesive surface is between a position at a distance of (2b−a)/4 in a longitudinal direction from an open section-side longitudinal direction end of the rear surface film and a position at a distance of (6b−a )/8 in the longitudinal direction from the open section-side longitudinal direction end of the rear surface film; and
an outer longitudinal direction end of the remaining part of the adhesive surface is between the open section-side longitudinal direction end of the rear surface film and the position at a distance of (2b−a)/4 in the longitudinal direction from the open section-side longitudinal direction end of the rear surface film.

[9] The packaging bag according to the foregoing [8], wherein “a” as a proportion relative to “b”, calculated by (a/b)×100, is 15% to 50%.

[10] The packaging bag according to the foregoing [8] or [9], further comprising

an inner film between the front surface film and the rear surface film, wherein

a longitudinal directional length of the inner film is short compared to a longitudinal direction length of the front surface film and the rear surface film,

a width direction length of the inner film is the same as a width direction length of the front surface film and the rear surface film,

the inner film is affixed to an open section-side longitudinal direction-end edge of the front surface film or the rear surface film at an open section-side longitudinal direction-end edge of the packaging bag, and

the inner film is sandwiched between and affixed to the front surface film and the rear surface film at both width direction-end edges of the packaging bag.

[11] The packaging bag according to the foregoing [10], wherein

the longitudinal direction length of the inner film is longer than a longitudinal direction length from the open section-side longitudinal direction end of the front surface film or the rear surface film to an open section-side longitudinal direction end of the adhesive layer.

[12] The packaging bag according to any one of the foregoing [8] to [11], wherein

the front surface film and the rear surface film are affixed to each other via a bottom surface film at a first longitudinal direction end.

[13] The packaging bag according to any one of the foregoing [8] to [12], further comprising:

at least one first mark including a first part and a second part, wherein the first part of the first mark is disposed along the open section-side longitudinal direction end of the rear surface film and the second part of the first mark is disposed at a part of the front surface film on which the adhesive layer is disposed such that the first part and the second part of the first mark become positioned to compose the first mark when the packaging bag is bent at a first position located further to an open section side than an open section-side longitudinal direction end of the adhesive layer, and the open section-side longitudinal direction end of the front surface film is affixed to a first part of the adhesive layer;

at least one second mark including a first part and a second part, wherein the first part of the second mark is disposed along the open section-side longitudinal direction end of the front surface film at an open section side of the first position of the front surface film or the rear surface film, and the second part of the second mark is disposed along the closed section-side longitudinal direction end of the adhesive layer at a closed section side thereof at the front surface film or the rear surface film such that the first part and the second part of the second mark become positioned to compose the second mark when the packaging bag is bent at the first position and the open section-side longitudinal direction end of the front surface film is affixed to the first part of the adhesive layer, and subsequently the packaging bag is bent at a second position of the rear surface film that is located further to the open section side than the first position and part of the rear surface film is affixed to a second part of the adhesive layer; and

at least one third mark including a first part and a second part, wherein the first part of the third mark is disposed along an outer longitudinal direction end of the seal at an opposite surface to the adhesive surface and the second part of the third mark is disposed along the open section-side longitudinal direction end of the front surface film at a closed section side of a third position of the front surface film that is located further to a longitudinal direction closed section side of the front surface film than the adhesive layer such that the first part and the second part of the third mark become positioned to compose the third mark when the packaging bag is bent at the first position and the open section-side longitudinal direction end of the front surface film is affixed to the first part of the adhesive layer, the packaging bag is then bent at the second position and part of the rear surface film is affixed to the second part of the adhesive layer, and subsequently the remaining part of the adhesive surface is affixed to the front surface film such that the seal covers the first part and the second part of the adhesive layer.

[14] The packaging bag according to the foregoing [13], wherein

the first mark, the second mark, and the third mark differ from one another in terms of either or both of color and shape.

[15] The packaging bag according to the foregoing [13] or [14], further comprising

a first bending line disposed along the open section-side longitudinal direction end of the front surface film at the first position of the front surface film and a second bending line disposed along the open section-side longitudinal direction end of the rear surface film at the second position of the rear surface film.

[16] A use of a packaging bag comprising, with respect to the packaging bag according to any one of the foregoing [13] to [15]:

bending the packaging bag at the first position and affixing the open section-side longitudinal direction end of the front surface film to the first part of the adhesive layer such that the first part and the second part of the first mark compose the first mark;

bending the packaging bag at the second position and affixing part of the rear surface film to the second part of the adhesive layer such that the first part and the second part of the second mark compose the second mark; and

affixing the remaining part of the adhesive surface to the front surface film such that the first part and the second part of the third mark compose the third mark, and such that the seal covers the first part and the second part of the adhesive layer.

[17] A method of manufacturing a packaging body comprising, with respect to the packaging bag according to any one of the foregoing [13] to [15]:

bending the packaging bag at the first position and affixing the open section-side longitudinal direction end of the front surface film to the first part of the adhesive layer such that the first part and the second part of the first mark compose the first mark;

bending the packaging bag at the second position and affixing part of the rear surface film to the second part of the adhesive layer such that the first part and the second part of the second mark compose the second mark; and

affixing the remaining part of the adhesive surface to the front surface film such that the first part and the second part of the third mark compose the third mark, and such that the seal covers the first part and the second part of the adhesive layer.

### Advantageous Effect

The disclosed packaging body has excellent pressure resistance. Moreover, the disclosed packaging bag can be tightly sealed with ease at the open section thereof and has excellent post-sealing pressure resistance.

### BRIEF DESCRIPTION OF THE DRAWINGS

In the accompanying drawings:

FIG. 1 is a schematic view (perspective view) of a packaging body illustrating one example of a present embodiment;

FIG. 2 is a schematic view (perspective view) of a packaging bag illustrating one example of the present embodiment;

FIG. 3 is a plan view from a front surface film side of the packaging bag illustrated in FIG. 2;

FIG. 4 is a plan view from a rear surface film side of the packaging bag illustrated in FIG. 2;

FIG. 5 is a cross-sectional view illustrating a Y-Y cross-section indicated in FIG. 3;

FIG. 6 is a schematic view (perspective view) of a packaging bag illustrating another example of the present embodiment;

FIG. 7 is a plan view from a front surface film side of the packaging bag illustrated in FIG. 6;

FIG. 8 is a plan view from a rear surface film side of the packaging bag illustrated in FIG. 6;

FIG. 9 illustrates the appearance of the packaging bag illustrated in FIG. 6 when the packaging bag is bent at a first position in a longitudinal direction;

FIG. 10 illustrates the appearance of the packaging bag illustrated in FIG. 6 when the packaging bag is bent at a second position in the longitudinal direction;

FIG. 11 illustrates the appearance of the packaging bag illustrated in FIG. 6 when the packaging bag is sealed with a seal;

FIGS. 12A, 12B, 12C, 12D, and 12E are schematic views of a use of a packaging bag illustrating one example of the present embodiment and a method of manufacturing a packaging body of the present embodiment;

FIG. 13 is a cross-sectional view illustrating an X-X cross-section indicated in FIG. 1;

FIG. 14 is a schematic view illustrating a packaging body manufactured by the method of manufacturing a packaging body of the present embodiment using the packaging bag illustrated in FIG. 6; and

FIGS. 15A and 15B illustrate dimensions of a packaging bag and bending positions in tight sealing of an open section.

### DETAILED DESCRIPTION

The following refers to the drawings as necessary to provide a detailed description of a disclosed embodiment (hereinafter, referred to simply as “the present embodiment”). The present embodiment set forth below is merely an example to aid explanation of this disclosure, which is not limited to the present embodiment and may be implemented with appropriate alterations

### Packaging Body

The disclosed packaging body includes at least a front surface film, a rear surface film, an adhesive layer on the front surface film, and a seal on the rear surface film, wherein

the front surface film and the rear surface film are affixed to each other at both width direction-end edges and at a first longitudinal direction-end edge to form a closed section at a first longitudinal direction-end side, and part of the front surface film and part of the rear surface film are affixed to the adhesive layer to form a tightly sealed section at a second longitudinal direction-end side,

at the tightly sealed section, the packaging body includes at least a layered structure I in which the front surface film, the rear surface film, and the adhesive layer are stacked in an order of adhesive layer/front surface film/rear surface film/rear surface film/front surface film/front surface film/rear surface film in a packaging body thickness direction, and a layered structure II in which the front surface film, the rear surface film, and the adhesive layer are stacked in an order of adhesive layer/rear surface film/front surface film/front surface film/rear surface film in the packaging body thickness direction, and

the layered structure I and the layered structure II are covered by the seal.

In this specification, the term “second longitudinal direction-end side” refers to an open section side of a packaging bag in terms of a longitudinal direction when contents are placed in the packaging bag and the term “first longitudinal direction-end side” refers to a closed section side of the packaging bag in terms of the longitudinal direction. In other words, in the packaging bag, a “second longitudinal direction end” is the same as an “open section-side longitudinal direction end” and a “first longitudinal direction end” is the same as a “closed section-side longitudinal direction end”.

The term “edge” refers to a region of a specific width that includes the entire length of an outer contour forming the corresponding end.

When the front surface film and the rear surface film are referred to as being “affixed”, this means that the front surface film and the rear surface film are affixed to form a structure through which air does not pass, and is inclusive, for example, of a case in which the front surface film and the rear surface film are directly affixed to each other, a case in which the front surface film and the rear surface film are affixed such as to sandwich another film or the like therebetween, and a case in which the front surface film and the rear surface film are affixed such as to sandwich a film or the like that is folded one or more times therebetween.

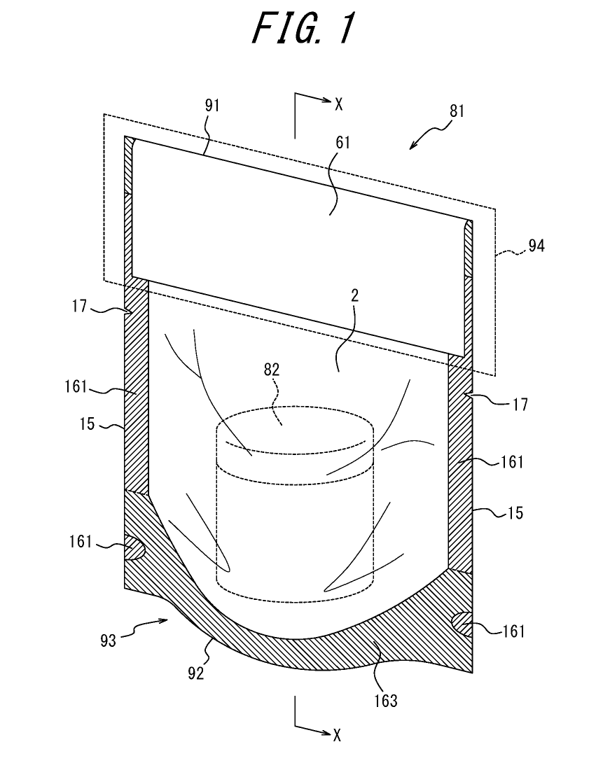

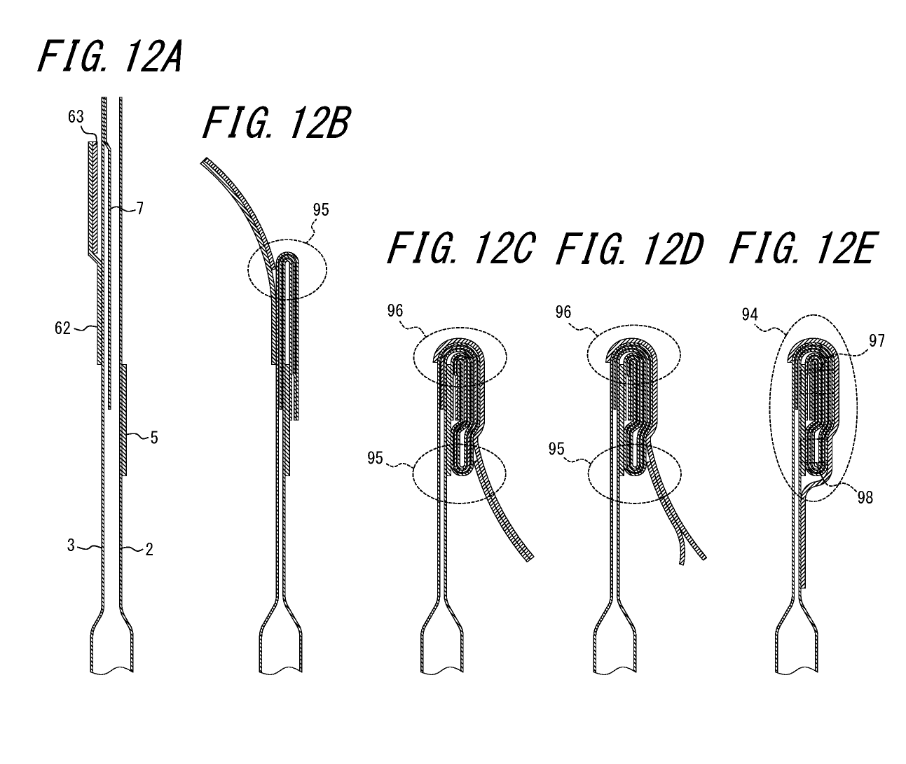

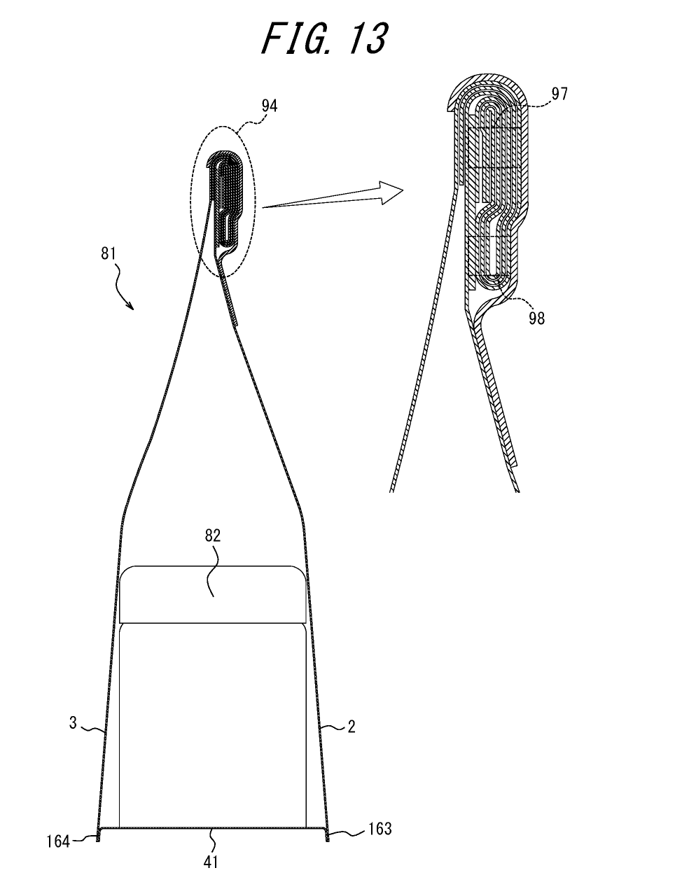

FIG. 1 is a schematic view (perspective view) illustrating an example of the packaging body of the present embodiment. The packaging body 81 illustrated in FIG. 1 is a tightly sealed packaging body in which contents 82 have been placed in a packaging bag including a front surface film 2 and a rear surface film 3, and having a closed section at both width direction end 15 sides and a first longitudinal direction end 92 side, and in which a tightly sealed section 94 has been formed at a second longitudinal direction end 91 side. The tightly sealed section 94 is covered by a seal 61. Part of the front surface film 2 and part of the rear surface film 3 are affixed to an adhesive layer 5 on the front surface film 2 such that the tightly sealed section 94 includes at least a layered structure I stacked in an order of adhesive layer/front surface film/rear surface film/rear surface film/front surface film/front surface film/rear surface film in a packaging body thickness direction, and a layered structure II stacked in an order of adhesive layer/rear surface film/front surface film/front surface film/rear surface film in the packaging body thickness direction (refer to FIGS. 12A to 12E and 13).

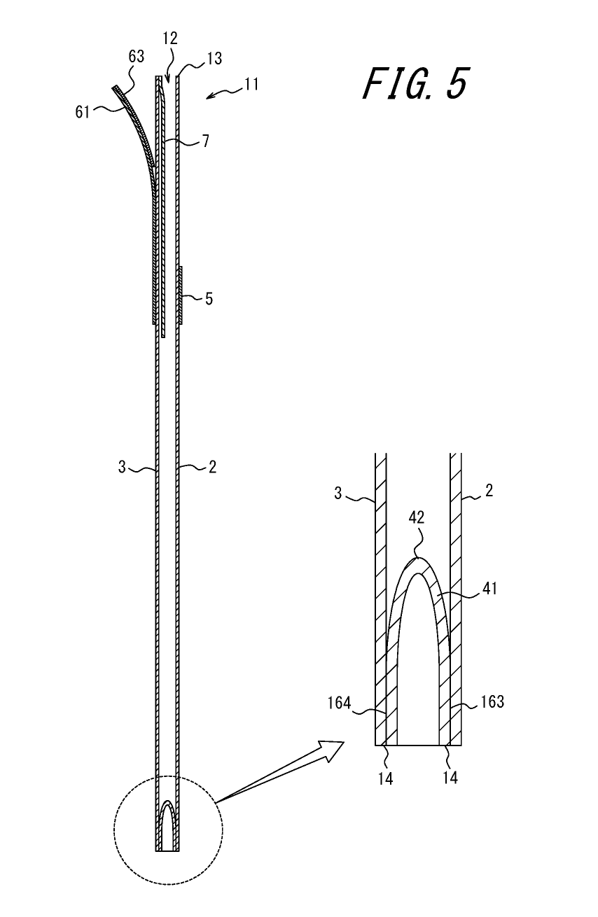

At the first longitudinal direction end 92 of the packaging body 81 illustrated in FIG. 1, a bottom surface film 41 that is folded in two at a fold 42 is affixed at a front surface film/bottom surface film heat sealed section 163 and a rear surface film/bottom surface film heat sealed section 164 (refer to FIGS. 5 and 13) to form a closed section 93.

At the width direction ends 15 at both sides of the packaging body 81 illustrated in FIG. 1, front surface film/rear surface film heat sealed sections 161 where the front surface film 2 and the rear surface film 3 are directly affixed to each other, the front surface film/bottom surface film heat sealed section 163, and the rear surface film/bottom surface film heat sealed section 164 are formed such that the edges at both width direction sides of the packaging body 81 are closed sections. In the packaging body 81 illustrated in FIG. 1, the front surface film 2 and the rear surface film 3 are affixed to each other at front surface film/rear surface film heat sealed sections 161 that are present within the front surface film/bottom surface film heat sealed section 163 and the rear surface film/bottom surface film heat sealed section 164 such that the packaging body 81 has a structure that facilitates free-standing by restricting excessive opening out of the bottom surface film 41 while the packaging body 81 is in a free-standing state (refer to FIG. 13). In the present example, the bottom surface film 41 is cut away in accordance with the shape of the front surface film/rear surface film heat sealed sections 161 within the front surface film/bottom surface film heat sealed section 163 and the rear surface film/bottom surface film heat sealed section 164 such that the bottom surface film 41 is not sandwiched between the front surface film and the rear surface film.

From a viewpoint of facilitating unsealing of the packaging body 81 illustrated in FIG. 1 after packaging, it is preferable that a notch 17 is provided in part of a width direction end 15. The notch 17 may be a section that has been cut away, or may, for example, be a cut line.

First, a description is provided of the packaging bag from which the packaging body of the present embodiment is formed.

(Packaging Bag)

The packaging bag used in the packaging body of the present embodiment and the packaging bag of the present embodiment may, for example, be a packaging bag in which a front surface film and a rear surface film are affixed to each other at both width direction-end edges and at a first longitudinal direction-end edge to form a closed section at a first longitudinal direction-end side and an open section at a second longitudinal direction-end side, an adhesive layer of the same width as the front surface film is disposed at a packaging bag outer side of the front surface film, a seal having an adhesive surface as at least one surface thereof is disposed at a packaging bag outer side of the rear surface film, and one part of the adhesive surface is attached to the rear surface film and a remaining part of the adhesive surface is attached to release paper.

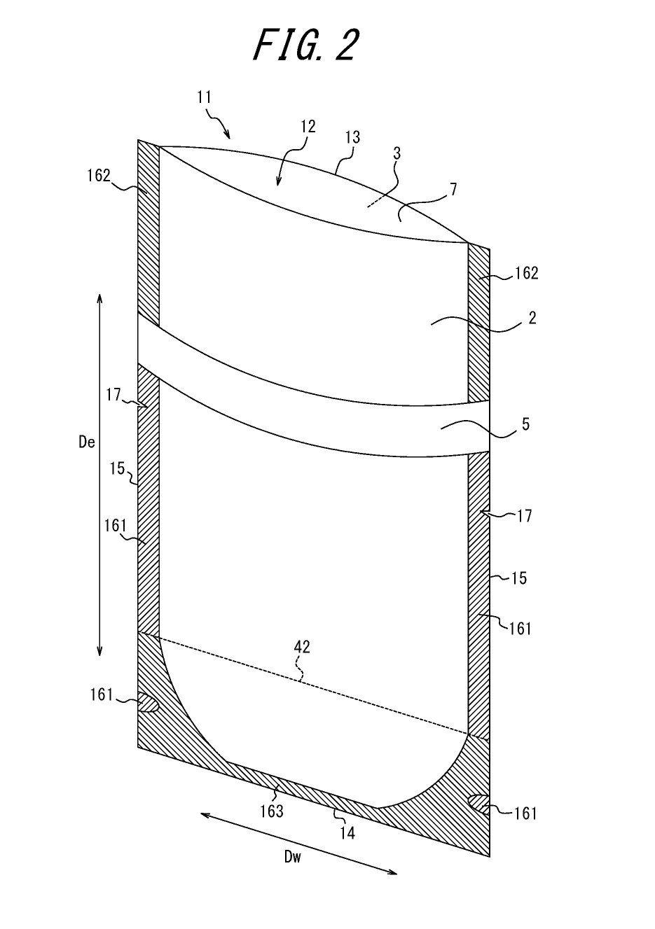

FIG. 2 is a schematic view (perspective view) illustrating one example of the packaging bag used in the packaging body of the present embodiment and the packaging bag of the present embodiment. The packaging bag 11 illustrated in FIG. 2 includes a front surface film 2, a rear surface film 3, a bottom surface film 41, an adhesive layer 5, a seal 61, and an inner film 7.

At a closed section-side longitudinal direction end 14 of the packaging bag 11 illustrated in FIG. 2, the bottom surface film 41 is folded in two at a fold 42 and is affixed at a front surface film/bottom surface film heat sealed section 163 and a rear surface film/bottom surface film heat sealed section (refer to FIGS. 5 and 13) to form a closed section 93.

Moreover, at width direction-end edges 15 at both sides of the packaging bag 11 illustrated in FIG. 2, front surface film/rear surface film/inner film heat sealed sections 162, front surface film/rear surface film heat sealed sections 161, the front surface film/bottom surface film heat sealed section 163, and the rear surface film/bottom surface film heat sealed section 164 are formed such that closed sections 93 are also formed at the edges at both width direction sides.

Furthermore, at an open section-side longitudinal direction end 13 of the packaging bag 11 illustrated in FIG. 2, the front surface film 2, the rear surface film 3, and the inner film 7 are affixed to one another at the front surface film/rear surface film/inner film heat sealed sections 162 positioned at both width direction-end sides, but at a remaining part of the open section-side longitudinal direction end 13, the inner film 7 is only affixed to the rear surface film 3 and thus an open section 12 is formed at the remaining part.

In the packaging bag 11 illustrated in FIG. 2, the adhesive layer 5 is disposed at a packaging bag outer side of the front surface film 2 and the seal 61 is disposed at a packaging bag outer side of the rear surface film 3.

Moreover, in the packaging bag 11 illustrated in FIG. 2, it is preferable that a notch 17 is provided in part of a width direction end 15 from a viewpoint of facilitating unsealing of a packaging body obtained after tight sealing. Note that in FIG. 2, “De” indicates the longitudinal direction and “Dw” indicates the width direction.

The shape of the front surface film 2 and the rear surface film 3 of the packaging bag 11 is not specifically limited and may, for example, be a quadrilateral shape such as a rectangle.

The length and/or width of the front surface film 2 and the rear surface film 3 of the packaging bag 11 may be the same or different, but from a viewpoint of further improving tight sealability, it is preferable that the front surface film 2 and the rear surface film 3 have the same length and width.

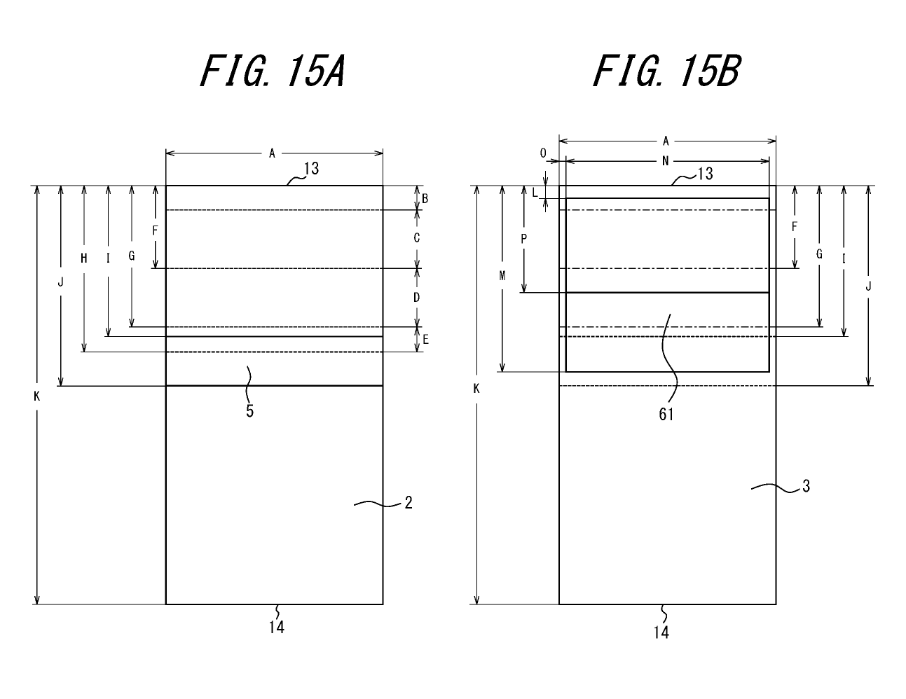

The length of the front surface film 2 and the rear surface film 3 (“K” in FIGS. 15A and 15B) is, for example, preferably 100 mm to 700 mm, and more preferably 150 mm to 650 mm. The width of the front surface film 2 and the rear surface film 3 (“A” in FIGS. 15A and 15B) is, for example, preferably 40 mm to 400 mm, and more preferably 50 mm to 350 mm.

The method by which the front surface film 2 and the rear surface film 3 are affixed to each other is preferably heat sealing from a viewpoint of obtaining even better pressure resistance. The width of affixed sections is preferably the same at both width direction-end edges and the first longitudinal direction-end edge from a viewpoint of efficiency of affixing operation, and is preferably 5 mm to 30 mm from a viewpoint of obtaining even better tight sealability.

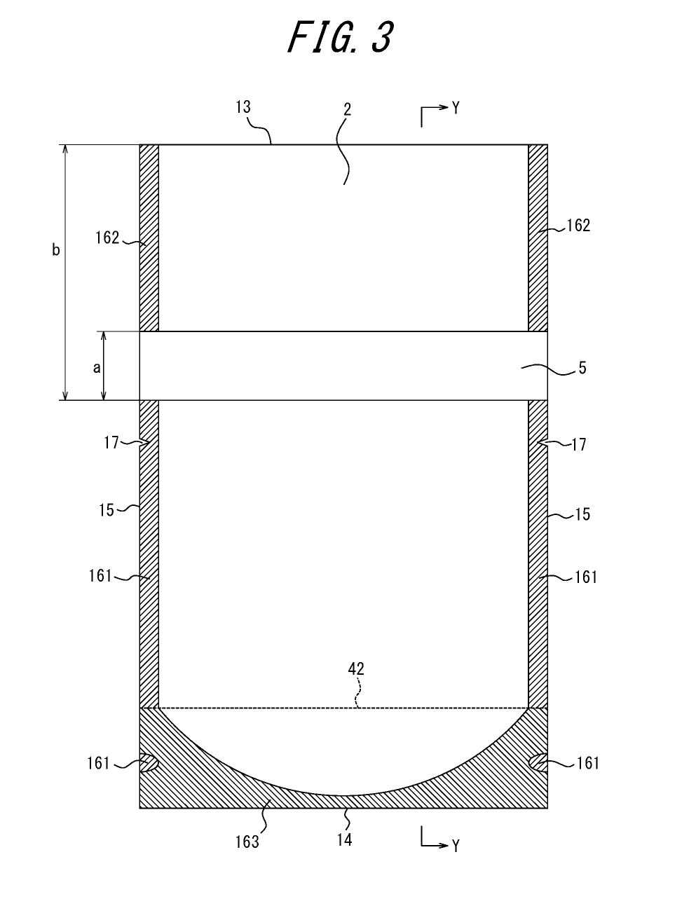

FIG. 3 is a plan view from a front surface film side of the packaging bag illustrated in FIG. 2. In the packaging bag 11 illustrated in FIG. 3, an adhesive layer 5 of the same width as the front surface film 2 is disposed on the front surface film 2. Release paper may be disposed on the surface of the adhesive layer 5 at a side thereof that is not in contact with the front surface film.

The adhesive layer 5 may, for example, be an adhesive layer formed from an adhesive such as an acrylic-based adhesive, a rubber-based adhesive, a silicone-based adhesive, or a urethane-based adhesive. For example, the adhesive layer 5 may be a double-sided adhesive sheet formed from only an adhesive layer, a double-sided adhesive sheet in which adhesive layers are disposed at both sides of a substrate, or the like.

The length from an open section-side longitudinal direction end of the front surface film 2 to an open section-side longitudinal direction end of the adhesive layer 5 (“I” in FIGS. 15A and 15B) is, for example, preferably 30 mm to 200 mm, and more preferably 40 mm to 150 mm from a viewpoint of facilitating tight sealing of the packaging bag.

The longitudinal direction length “a” of the adhesive layer 5 (“J-I” in FIGS. 15A and 15B) is, for example, preferably 15 mm to 80 mm, and more preferably 20 mm to 70 mm from a viewpoint of obtaining even better tight sealability and facilitating attachment.

When the longitudinal direction length of the adhesive layer 5 is taken to be “a” and the longitudinal direction length from the open section-side longitudinal direction end of the front surface film 2 to a closed section-side longitudinal direction end of the adhesive layer 5 is taken to be “b” (“J” in FIGS. 15A and 15B), “a” as a proportion (a/b×100) relative to “b” (“(J-I)/J ×100” in FIGS. 15A and 15B) is, for example, preferably 15% to 80%, more preferably 15% to 70%, even more preferably 15% to 50%, and particularly preferably 20% to 50% from a viewpoint of obtaining even better tight sealability and facilitating attachment.

The length from the open section-side longitudinal direction end of the front surface film 2 to the open section-side longitudinal direction end of the adhesive layer 5 as a proportion relative to the width direction length of the front surface film 2 (“I/A×100” in FIGS. 15A and 15B) is preferably 30% to 70% from a viewpoint of obtaining even better post-sealing pressure resistance.

The length from the open section-side longitudinal direction end of the front surface film 2 to the closed section-side longitudinal direction end of the adhesive layer 5 as a proportion relative to the width direction length of the front surface film 2 (“J/A×100” in FIGS. 15A and 15B) is preferably 40% to 90% from a viewpoint of obtaining even better post-sealing pressure resistance. Note that the length from the open section-side longitudinal direction end of the front surface film 2 to the closed section-side longitudinal direction end of the adhesive layer 5 as a proportion relative to the width direction length of the front surface film 2 is a larger value than the length from the open section-side longitudinal direction end of the front surface film 2 to the open section-side longitudinal direction end of the adhesive layer 5 as a proportion relative to the width direction length of the front surface film 2.

The longitudinal direction length of the adhesive layer 5 as a proportion relative to the width direction length of the front surface film 2 (“(J-I)/A×100” in FIGS. 15A and 15B) is preferably 6% to 25% from a viewpoint of obtaining even better post-sealing pressure resistance.

In the packaging bag 11 illustrated in FIG. 3, the closed section 93 at the closed section-side longitudinal direction end 14 is formed from the front surface film 2, the rear surface film 3, and the bottom surface film 41.

From a viewpoint of enabling free-standing of a packaging body obtained after contents have been placed and been tightly sealed in the packaging bag of the present embodiment, and also from a viewpoint of restricting movement of contents 82 inside the packaging body 81, it is preferable that the closed section at the closed section-side longitudinal direction end 14 has a structure that enables free-standing after contents 82 have been placed and tightly sealed in the packaging bag 11. The structure that enables free-standing may, for example, be a structure in which a film having one or more folds is sandwiched between the front surface film 2 and the rear surface film 3 at the closed section 93 of the closed section-side longitudinal direction end 14.

At the closed section 93 of the closed section-side longitudinal direction end 14 in the packaging bag 11 illustrated in FIG. 3, the front surface film 2, the bottom surface film 41 folded in two at the fold 42, and the rear surface film 3 are stacked in this order, and the front surface film 2 and the bottom surface film 41 are heat sealed at the front surface film/bottom surface film heat sealed section 163, whereas the rear surface film 3 and the bottom surface film 41 are heat sealed at the rear surface film/bottom surface film heat sealed section 164 (refer to FIG. 5).

The shape of the bottom surface film 41 may, for example, be a quadrilateral shape such as a rectangle. Also, the bottom surface film 41 may have one fold or may have a plurality of folds.

The width of the bottom surface film 41 is, for example, preferably the same as the front surface film 2 and the rear surface film 3.

The method by which the bottom surface film 41 is affixed to the front surface film 2 and/or the rear surface film 3 is preferably heat sealing from a viewpoint of obtaining even better pressure resistance. Moreover, from a viewpoint of tight sealability, it is preferable that at both width direction ends 15 and the closed section-side longitudinal direction end 14, the bottom surface film 41 is affixed such as to overlap with the width direction ends and the closed section-side longitudinal direction end of the film to which the bottom surface film 41 is affixed.

In terms of the shape of the front surface film/bottom surface film heat sealed section 163 as viewed from a front surface film side, it is preferable that the longitudinal direction length of the heat sealed section from the closed section-side longitudinal direction end is longer toward the width direction ends than toward the width direction center. This is because when the fold 42 of the bottom surface film 41 is opened out after contents 82 are placed and sealed in the packaging bag 11, the shape at the longitudinal direction closed section side after opening out of the fold 42 (shape when viewed toward the first longitudinal direction end 92 from the second longitudinal direction end 91) is wider at a width direction central section and narrower at width direction-end sides, which restricts movement of contents 82 in the packaging body 81. Specifically, it is preferable that heat sealing is performed with a shape in which the heat seal width at a width direction central section is short and the heat seal width at width direction-end sides is long, and more specifically with an arc shape as illustrated in FIG. 3.

The shape of the rear surface film/bottom surface film heat sealed section 164 as viewed from a rear surface film side is preferably the same type of shape.

Moreover, from a viewpoint of enabling an appropriate degree of opening out at the fold 42 of the bottom surface film 41 after contents 82 have been placed inside, without excessive opening out of the fold 42, and further restricting movement of contents 82 inside the packaging body 81, it is preferable that front surface film/rear surface film heat sealed sections 161 are provided within the front surface film/bottom surface film heat sealed section 163 and the rear surface film/bottom surface film heat sealed section 164 at a section of the width direction ends 15 of the packaging bag 11 such that the front surface film 2 and the rear surface film 3 are affixed to each other. Specifically, sections of the bottom surface film 41 corresponding to these front surface film/rear surface film heat sealed sections 161 may be cut away, and the front surface film 2 and the rear surface film 3 may be affixed to each other, or the front surface film 2 and the rear surface film 3 may be affixed to each other via the bottom surface film 41. The shape of the front surface film/rear surface film heat sealed sections 161 within the front surface film/bottom surface film heat sealed section 163 and the rear surface film/bottom surface film heat sealed section 164 (shape viewed from the front surface film 2 side) is, for example, a semicircular shape or the like (FIG. 3).

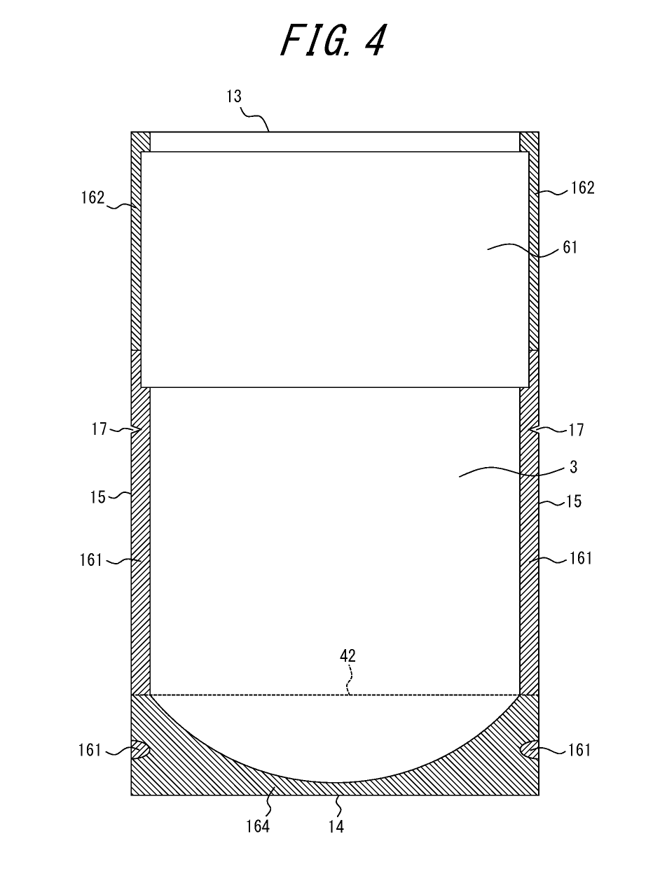

FIG. 4 is a plan view from a rear surface film side of the packaging bag illustrated in FIG. 2. In the packaging bag 11 illustrated in FIG. 4, a seal 61 having an adhesive surface 62 as at least one surface thereof is disposed on the rear surface film 3. One part of the adhesive surface 62 of the seal 61 is attached to the rear surface film 3 and a remaining part of the adhesive surface 62 is attached to release paper 63.

The adhesive surface 62 of the seal 61 includes, in the longitudinal direction, the one part at which the adhesive surface 62 is exposed and the remaining part at which the release paper 63 is attached. The seal 61 is attached to the rear surface film 3 such that the one part at which the adhesive surface 62 is exposed is at a longitudinal direction closed section side of the rear surface film 3 and the remaining part at which the release paper 63 is attached is at a longitudinal direction open section side of the rear surface film 3 (refer to FIG. 5).

The seal 61 may be a double-sided adhesive seal having adhesive surfaces at both sides thereof or may be a single-sided adhesive seal having an adhesive surface at one side thereof. In the case of a double-sided adhesive seal, it is preferable from a viewpoint of ease of an operation of tightly sealing the open section that release paper 63 is disposed on the remaining part of the adhesive surface at one side of the seal and that release paper is disposed over the whole of the adhesive surface at the other side of the seal.

The seal 61 may be a commonly known adhesive seal. For example, the adhesive surface 62 may be the surface of an adhesive layer or the like formed from an adhesive such as an acrylic-based adhesive, a rubber-based adhesive, a silicone-based adhesive, or a urethane-based adhesive, and the release paper 63 may be release paper or the like in which a layer formed from a silicone-based release agent, a fluorine-containing release agent, or the like is disposed on a substrate.

The longitudinal direction length of the seal 61 (“M-L” in FIGS. 15A and 15B) is, for example, preferably 55 mm to 150 mm and more preferably 60 mm to 140 mm from a viewpoint of obtaining even better tight sealability and facilitating tight sealing of the open section.

The width direction length of the seal 61 may be the same as the width direction length of the rear surface film 3 or may be shorter than the width direction length of the rear surface film 3. The width direction length of the seal 61 is preferably 80% to 100% relative to the width direction length of the rear surface film 3 (100%) from a viewpoint of facilitating attachment of the seal.

The length from an open section-side longitudinal direction end of the adhesive layer 5 to a closed section-side longitudinal direction end of the seal 61 as a proportion relative to the width direction length of the rear surface film 3 (“(M-I)/A×100” in FIGS. 15A and 15B) is preferably 0% to 45% from a viewpoint of obtaining even better post-sealing pressure resistance.

The length from a closed section-side longitudinal direction end of the release paper 63 affixed to the adhesive surface 62 of the seal 61 to the open section-side longitudinal direction end of the adhesive layer 5 as a proportion relative to the width direction length of the rear surface film 3 (“(I-P)/A×100” in FIGS. 15A and 15B) is preferably 1% to 30% from a viewpoint of efficiency of an operation of attaching the adhesive surface 62 of the seal 61.

When the longitudinal direction length of the adhesive layer 5 is taken to be “a” and the longitudinal direction length from the open section-side longitudinal direction end of the front surface film 2 to the closed section-side longitudinal direction end of the adhesive layer 5 is taken to be “b”, it is preferable from a viewpoint of ease of sealing with the seal that an outer longitudinal direction end of the remaining part (part to which the release paper 63 is attached) of the adhesive surface 62 of the seal 61 (open section-side longitudinal direction end of the seal 61) is between the open section-side longitudinal direction end of the rear surface film 3 and a position at a distance of (2b-a)/4 in the longitudinal direction from the open section-side longitudinal direction end of the rear surface film 3. In other words, the outer longitudinal direction end of the remaining part of the adhesive surface 62 is preferably between the open section-side longitudinal direction end of the rear surface film 3 and a first bend section (refer to FIGS. 12A to 12E).

From a viewpoint of ease of sealing with the seal, an inner longitudinal direction end of the one part (part where the rear surface film 3 and the adhesive surface 62 are affixed, part where the release paper 63 is not affixed) of the adhesive surface 62 of the seal 61 (open section-side longitudinal direction end of a part where the rear surface film 3 and the adhesive surface 62 are affixed) is preferably between the position at a distance of (2b-a)/4 in the longitudinal direction from the open section-side longitudinal direction end of the rear surface film 3 and a position at a distance of (6b-a)/8 in the longitudinal direction from the open section-side longitudinal direction end of the rear surface film 3. In other words, the inner longitudinal direction end of the one part of the adhesive surface 62 is preferably between the first bend section (refer to FIGS. 12A to 12E) and a second bend section (refer to FIGS. 12A to 12E).

In the seal 61, the longitudinal direction length of the remaining part attached to the release paper 63 (“P-L” in FIGS. 15A and 15B) is preferably 25 mm to 70 mm from a viewpoint of ease of peeling of the release paper during use of the seal.

Moreover, in the seal 61, the longitudinal direction length of the one part attached to the rear surface film 3 (“M-P” in FIGS. 15A and 15B) is preferably 25 mm to 70 mm from a viewpoint of enabling even more secure tight sealing with the seal.

FIG. 5 is a cross-sectional view illustrating an Y-Y cross-section indicated in FIG. 3.

The packaging bag used in the packaging body of the present embodiment and the packaging bag of the present embodiment may further include an inner film 7 between the front surface film 2 and the rear surface film 3.

It is preferable that the longitudinal direction length of the inner film 7 is short compared to the longitudinal direction length of the front surface film 2 and the rear surface film 3, and that the width direction length of the inner film 7 is the same as the width direction length of the front surface film 2 and the rear surface film 3. Moreover, at an open section-side longitudinal direction-end edge of the packaging bag 11, the inner film 7 is preferably affixed to an open section-side longitudinal direction-end edge of the front surface film 2 or the rear surface film 3, and at both width direction-end edges of the packaging bag 11, the inner film 7 is preferably sandwiched between and affixed to the front surface film 2 and the rear surface film 3.

In the packaging bag 11 illustrated in FIGS. 2 to 5, the inner film 7 is affixed to the open section-side longitudinal direction-end edge of the rear surface film 3 and is not affixed to the open section-side longitudinal direction-end edge of the front surface film. Moreover, at both width direction ends 15 of the packaging bag 11, both width direction-end edges of the inner film 7 are sandwiched between and affixed to both width direction-end edges of the front surface film 2 and both width direction-end edges of the rear surface film 3.

The method by which the inner film 7 is affixed is preferably heat sealing. The width of affixed sections is preferably the same width at both width direction-end edges and one longitudinal direction-end edge from a viewpoint of efficiency of affixing operation, and is preferably 5 mm to 30 mm.

The longitudinal direction length of the inner film 7 is preferably longer than the length from the open section-side longitudinal direction end of the front surface film 2 or the rear surface film 3 to the open section-side longitudinal direction end of the adhesive layer 5 (i.e., “I<H” is preferable in FIGS. 15A and 15B) from a viewpoint of obtaining even better post-sealing pressure resistance and restricting scattering of contents in the event of sealed body rupturing.

The length from the open section-side longitudinal direction end of the adhesive layer 5 to a closed section-side longitudinal direction end of the inner film 7 as a proportion relative to the width direction length of the rear surface film 3 (“(H-I)/A×100” in FIGS. 15A and 15B) is preferably 1% to 30% and more preferably 1% to 20% from a viewpoint of obtaining even better post-sealing pressure resistance.

It is preferable that the front surface film 2, the rear surface film 3, the bottom surface film 41, and the inner film 7 can be affixed at edges thereof and, for reasons of practicality, it is preferable that the front surface film 2, the rear surface film 3, the bottom surface film 41, and the inner film 7 are heat sealable.

Each film among the front surface film 2, the rear surface film 3, the bottom surface film 41, and the inner film 7 includes a heat sealing layer, and may further include other layers as necessary, such as a substrate layer and a printing layer between the heat sealing layer and the substrate layer. Each film may have a single layer structure formed from a heat sealing layer or may have a multilayer structure including a heat sealing layer, and also a substrate layer and/or other layers. When these films are processed into the form of a bag, each of the films can be used such that the substrate layer becomes positioned at an outer side and the heat sealing layer becomes positioned at an inner side. Note that the inner film 7 may include a heat sealing layer at both sides thereof.

Examples of materials that can be used for a heat sealing layer include low-density polyethylene (LDPE), linear low-density polyethylene (LLDPE), ethylene-α-olefin copolymers, ethylene-vinyl acetate copolymers, ethylene-acrylic acid copolymers, ethylene-acrylic acid ester copolymers, polypropylene, and propylene copolymers. Low-density polyethylene (LDPE), linear low-density polyethylene (LLDPE), polypropylene, and propylene copolymers are preferable from a viewpoint of odor.

Suitable examples of materials that can be used for a substrate layer and an intermediate layer include stretched films made of polypropylene; biaxially stretched films of polyamides such as nylon 6, nylon 66, and MXD 6 (poly(m-xylylene adipamide)); and biaxially stretched films of polyester-based resins such as polyethylene terephthalate and polybutylene terephthalate. Moreover, a gas barrier film such as a film of a saponification product of ethylene-vinyl acetate copolymer (EVOH), polyvinylidene chloride (PVDC), polyacrylonitrile (PAN), or the like; aluminum foil; or a biaxially stretched nylon film, biaxially stretched polyethylene terephthalate film, biaxially stretched polypropylene film, or the like provided with a vapor deposited layer of silica, alumina, aluminum, or the like, or a PVDC coating layer may be used as a substrate layer or intermediate layer as necessary. Among these examples, a biaxially stretched film of a polyester-based resin such as polyethylene terephthalate or polybutylene terephthalate is preferable as a substrate layer from a viewpoint of obtaining even better post-sealing pressure resistance. Moreover, among these example, a biaxially stretched film of a polyamide such as nylon 6, nylon 66, or MXD 6 (poly(m-xylylene adipamide)) or a biaxially stretched nylon film provided with a PVDC coating layer is preferable as an intermediate layer from a viewpoint of preventing the formation of pin holes due to bending.

Lamination of a heat sealing layer, a substrate layer, and an intermediate layer may be performed by a commonly known dry lamination method or extrusion lamination method (sandwich lamination method). In the case of dry lamination, the type of adhesive is not specifically limited and may be selected in consideration of the type of contents, form of packaging, and so forth. For example, a one-part or two-part polyurethane-based adhesive is preferable, and a two-part polyester-based polyurethane adhesive is more preferable. In the case of extrusion lamination, examples of resins that can be used in extrusion include, but are not specifically limited to, low-density polyethylene (LDPE), linear low-density polyethylene (LLDPE), ethylene-a-olefin copolymers, ethylene-vinyl acetate copolymers, ethylene-acrylic acid copolymers, ethylene-acrylic acid ester copolymers, polypropylene, and propylene copolymers. Low-density polyethylene (LLDPE), linear low-density polyethylene (LLDPE), polypropylene, and propylene copolymers are preferable from a viewpoint of odor.

The thickness of the front surface film 2, the rear surface film 3, and the bottom surface film 41 of the packaging bag 11 may be 80 μm or more, and preferably 90 μm or more, and may be 230 μm or less, and preferably 200 μm or less.

The thickness of the inner film 7 of the packaging bag 11 may be 40 μm or more, and preferably 50 μm or more, and may be 150 μm or less, and preferably 140 μm or less.

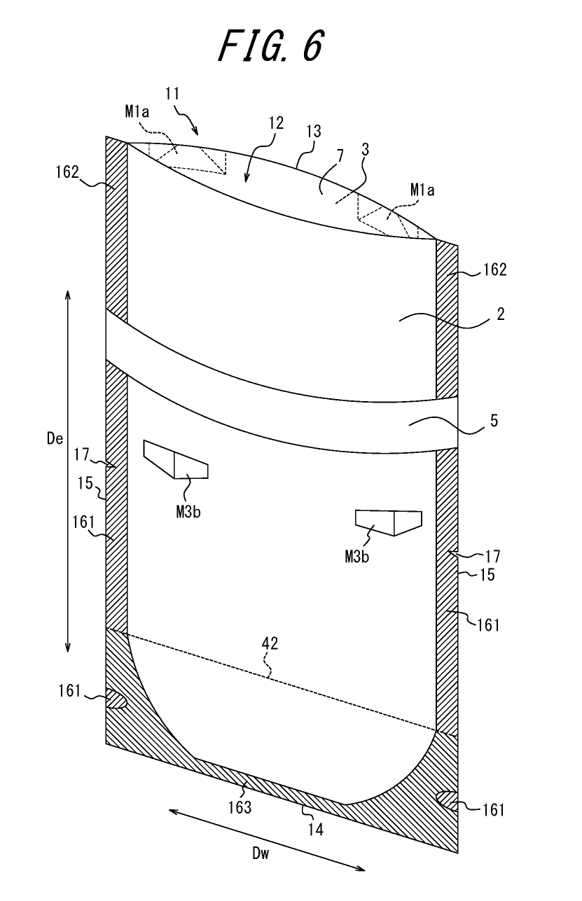

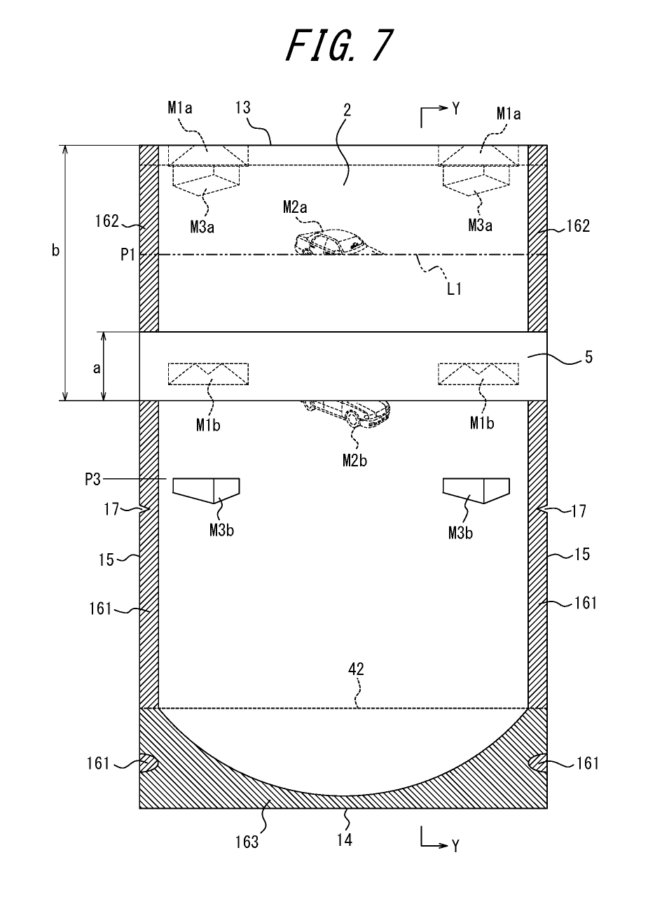

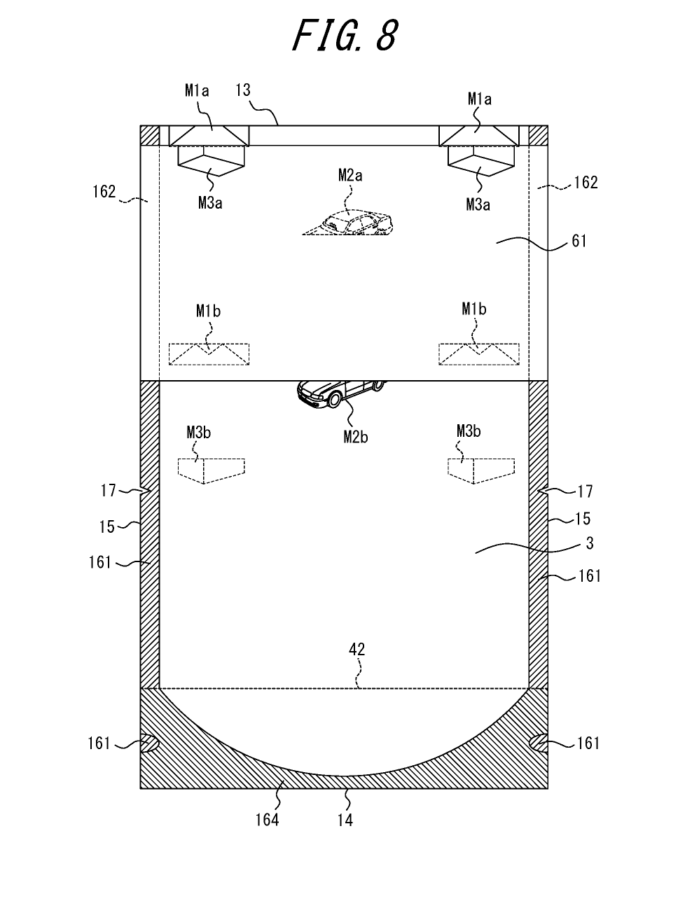

FIG. 6 is a schematic view (perspective view) illustrating another example of the packaging bag of the present embodiment. FIG. 7 is a plan view from a front surface film side of the packaging bag illustrated in FIG. 6 FIG. 8 is a plan view from a rear surface film 3 side of the packaging bag illustrated in FIG. 6.

In the packaging bag 11 illustrated in FIGS. 6 to 8, the packaging bag 11 illustrated in FIGS. 2 to 5 is provided with at least one first mark M1 (two in the example illustrated in FIGS. 7 and 8) including a first part M1a and a second part M1b, at least one second mark M2 (one in the example illustrated in FIGS. 7 and 8) including a first part M2a and a second part M2b, and at least one third mark M3 (two in the example illustrated in FIGS. 7 and 8) including a first part M3a and a second part M3b.

Specifically, the first part M1a of the first mark M1 is disposed along the open section-side longitudinal direction end 13 of the rear surface film 3 as illustrated in FIG. 8. On the other hand, the second part M1b of first mark M1 is disposed at a part of the front surface film 2 where the adhesive layer 5 is disposed as illustrated in FIG. 7.

Accordingly, when the packaging bag 11 is bent at a first position P1 that is located further to the open section 12 side than the open section-side longitudinal direction end of the adhesive layer 5, and the open section-side longitudinal direction end of the front surface film 2 is affixed to a first part of the adhesive layer 5, the divided first part M1a and second part M1b are united to compose the first mark M1.

The first part M2a of the second mark M2 is disposed along the open section-side longitudinal direction end of the front surface film 2 at an open section 12 side of the first position P1 of the rear surface film 3 as illustrated in FIG. 7. On the other hand, the second part M2b of the second mark M2 is disposed along the closed section-side longitudinal direction end of the adhesive layer 5 at a closed section side thereof at the rear surface film 3 as illustrated in FIG. 8.

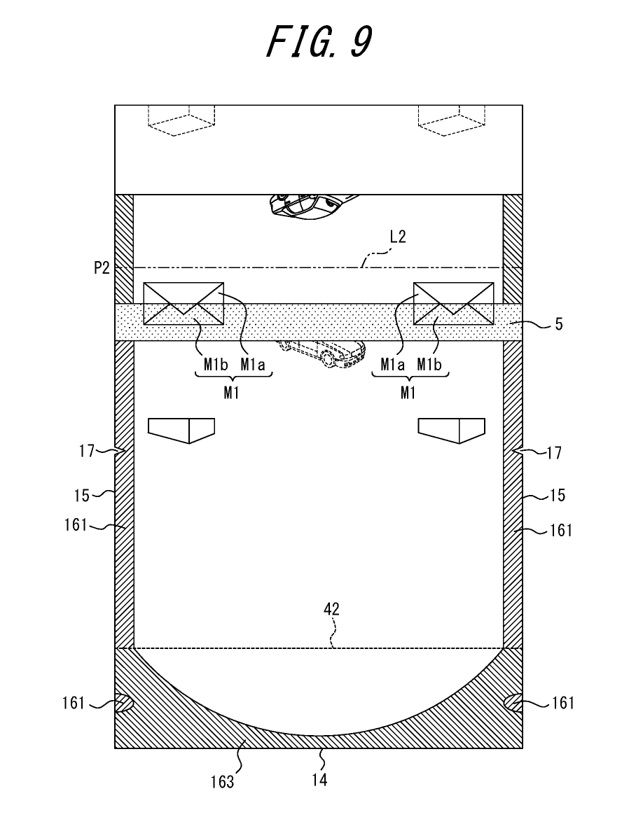

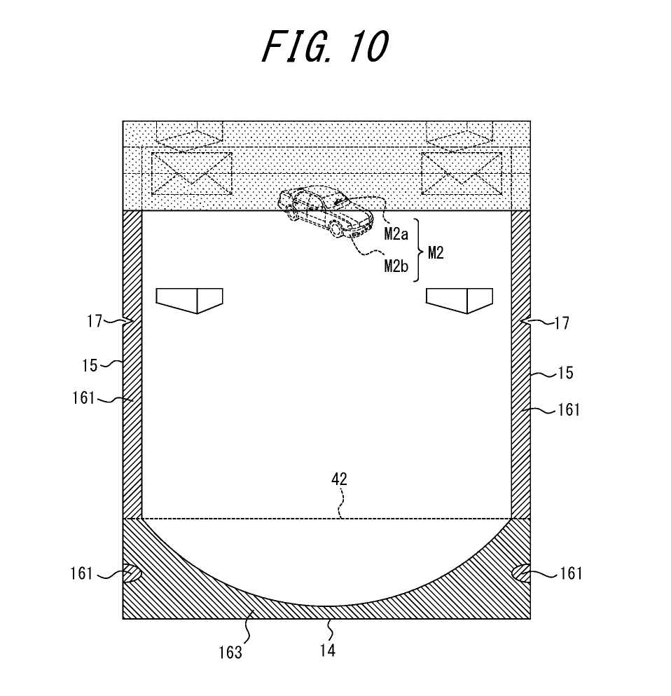

Accordingly, the first part M2a and the second part M2b of the second mark M2 are positioned such that when the packaging bag 11 is bent at the first position P1 and the open section-side longitudinal direction end of the front surface film 2 is affixed to the first part of the adhesive layer 5 as illustrated in FIG. 9, and then the packaging bag 11 is bent at a second position P2 of the rear surface film 3 that is further to the open section 12 side than the first position P1 and part of the rear surface film 3 is affixed to a second part of the adhesive layer 5, the divided first part M2a and second part M2b are united to compose the second mark M2 as illustrated in FIG. 10.

Note that the second mark M2 (first part M2a and second part M2b) may be provided at either the front surface film 2 or the rear surface film 3.

The first part M3a of the third mark M3 is disposed along an outer longitudinal direction end of the seal 61 at an opposite surface to the adhesive surface 62 as illustrated in FIG. 8. On the other hand, the second part M3b of the third mark M3 is disposed along the open section-side longitudinal direction end of the front surface film 2 at a closed section side of a third position P3 of the front surface film 2 that is located further to a longitudinal direction closed section side of the front surface film 2 than the adhesive layer 5 as illustrated in FIG. 7.

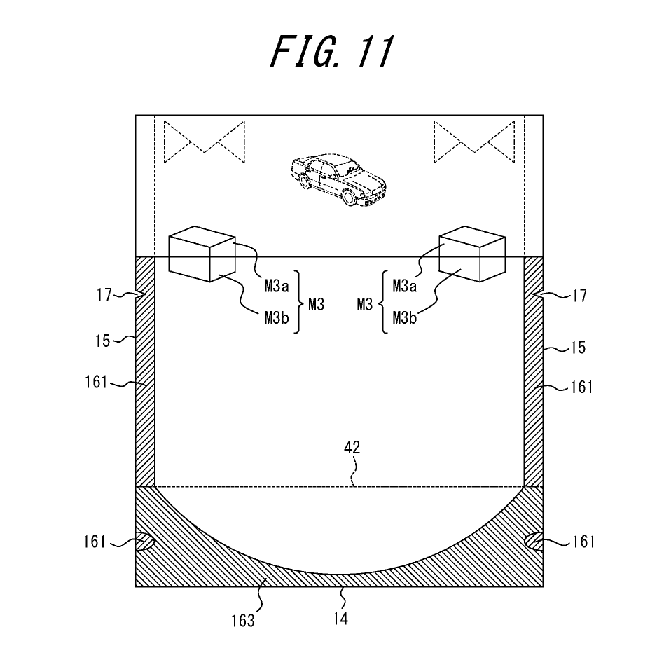

Accordingly, the first part M3a and the second part M3b of the third mark M3 are positioned such that when the packaging bag 11 is bent at the first position P1 and the open section-side longitudinal direction end of the front surface film 2 is affixed to the first part of the adhesive layer 5 as illustrated in FIG. 9, the packaging bag 11 is then bent at the second position P2 and part of the rear surface film 3 is affixed to the second part of the adhesive layer 5 as illustrated in FIG. 10, and subsequently the remaining part of the adhesive surface 62 is affixed to the front surface film 2 such that the seal 61 covers the first part and the second part of the adhesive layer 5, the divided first part M3a and second part M3b are united to compose the third mark M3 as illustrated in FIG. 11.

The first mark M1, the second mark M2, and the third mark M3 are not limited in terms of shape, color, and so forth. For example, the first mark M1, the second mark M2, and the third mark M3 may indicate the contents or method of transportation (automobile, airplane, train, boat, etc.), or may be a company or product logo.

Moreover, although no specific limitations are placed on the color of the first mark M1, the second mark M2, and the third mark M3, a color that is easily visible is preferable so that these marks can be easily checked.

It is preferable that the first mark Ml, the second mark M2, and the third mark M3 differ from one another in terms of either or both of color and shape. This facilitates correct sealing by an operator.

Moreover, it is preferable to provide a first bend line L1 disposed along the open section-side longitudinal direction end of the front surface film 2 at the first position P1 of the front surface film 2 and a second bend line L2 disposed along the open section-side longitudinal direction end of the rear surface film 3 at the second position P2 of the rear surface film 3. This enables an operator sealing the packaging bag to seal the packaging bag with greater ease.

The number of first marks M1, second marks M2, and third marks M3 is one or more of each. The number of each type of mark is preferably five or less, and most preferably two or three in order that an operator can easily unite each of the marks.

Although no specific limitations are placed on the size of the first mark M1, the second mark M2, and the third mark M3, a size that is easily visible to an operator is preferable.

In this manner, the packaging bag 11 illustrated in FIGS. 6 to 11 is provided with three divided marks and an operator sealing the packaging bag is guided to perform sealing correctly to obtain a packaging body having excellent post-sealing pressure resistance by carrying out sealing operation in a manner that unites the divided marks. Moreover, a collection agency that collects the packaging body can easily confirm that the packaging body is correctly sealed by checking the three marks on the packaging body.

(Use of Packaging Bag and Method of Manufacturing Packaging Body)

The following describes a method of manufacturing a packaging body of the present embodiment and a use of a packaging bag of the present embodiment. The method of manufacturing a packaging body of the present embodiment preferably includes, with respect to a packaging bag in which a front surface film and a rear surface film are affixed to each other at both width direction-end edges and at a first longitudinal direction-end edge to form a closed section at a first longitudinal direction-end side and an open section at a second longitudinal direction-end side, an adhesive layer of the same width as the front surface film is disposed at a packaging bag outer side of the front surface film, a seal having an adhesive surface as at least one surface thereof is disposed at a packaging bag outer side of the rear surface film, and one part of the adhesive surface is attached to the rear surface film and a remaining part of the adhesive surface is attached to release paper: bending the packaging bag in a longitudinal direction and affixing an open section-side longitudinal direction end of the front surface film to a first part of the adhesive layer; further bending the packaging bag in the longitudinal direction and affixing part of the rear surface film to a second part of the adhesive layer; and affixing the remaining part of the adhesive surface to the front surface film such that the seal covers the first part and the second part of the adhesive layer.

The use of a packaging bag of the present embodiment preferably includes, with respect to a packaging bag in which a front surface film and a rear surface film are affixed to each other at both width direction-end edges and at a first longitudinal direction-end edge to form a closed section at a first longitudinal direction-end side and an open section at a second longitudinal direction-end side, an adhesive layer of the same width as the front surface film is disposed at a packaging bag outer side of the front surface film, a seal having an adhesive surface as at least one surface thereof is disposed at a packaging bag outer side of the rear surface film, and one part of the adhesive surface is attached to the rear surface film and a remaining part of the adhesive surface is attached to release paper: bending the packaging bag in a longitudinal direction and affixing an open section-side longitudinal direction end of the front surface film to a first part of the adhesive layer; further bending the packaging bag in the longitudinal direction and affixing part of the rear surface film to a second part of the adhesive layer; and affixing the remaining part of the adhesive surface to the front surface film such that the seal covers the first part and the second part of the adhesive layer.

FIGS. 12A to 12E are schematic views illustrating the method of manufacturing a packaging body of the present embodiment and the use of a packaging bag of the present embodiment. FIGS. 12A to 12E illustrate, in enlarged form, a cross-section of a packaging bag 11 near to an open section in a longitudinal direction. FIG. 12A illustrates the packaging bag prior to tight sealing of the open section. An adhesive layer 5 is disposed on a front surface film 2, a seal 61 is disposed on a rear surface film 3, and an inner film 7 is disposed between the front surface film 2 and the rear surface film 3.

FIG. 12B is a schematic view illustrating first bending in which the packaging bag 11 is bent in the longitudinal direction and an open section-side longitudinal direction end of the front surface film 2 is affixed to a first part of the adhesive layer 5. The method by which the packaging bag is bent in the first bending may be folding at a first bend section or may be curling of the packaging bag without folding at a bend section. In FIG. 12B, the packaging bag is folded at a first bend section 95.

In the first bending, the front surface film 2 is affixed to the first part of the adhesive layer 5 such that the rear surface film 3 can also be affixed to the adhesive layer 5 in the subsequently described second bending. The first part at which the front surface film 2 and the adhesive layer 5 are affixed to each other in the first bending is preferably 30% to 60% relative to the longitudinal direction length of the adhesive layer 5 (100%) from a viewpoint of facilitating affixing of the rear surface film to the adhesive layer in the second bending and obtaining even better post-sealing pressure resistance.

The adhesive layer 5 may be provided as two or more parts that are separated in the longitudinal direction. For example, the first part of the adhesive layer to which the front surface film 2 is affixed in the first bending and a second part of the adhesive layer to which the rear surface film 3 is affixed in the subsequently described second bending may be separated from one another in the longitudinal direction.

FIG. 12C is a schematic view illustrating second bending in which the packaging bag 11 is further bent in the longitudinal direction and part of the rear surface film 3 is attached to the second part of the adhesive layer 5. The method by which the packaging bag is bent in the second bending may be folding at a second bend section or may be curling of the packaging bag without folding at a bend section. In FIG. 12C, the packaging bag is folded at a second bend section 96.

Through the first bending and the second bending, a tightly sealed section 94 is formed with the second bend section 96 at a second longitudinal direction end 91 side and the first bend section 95 at a first longitudinal direction end 92 side. At the tightly sealed section 94, the first bend section 95 may be positioned on the adhesive layer 5 or may not be positioned on the adhesive layer 5. Of these configurations, a configuration in which the first bend section is positioned on the adhesive layer 5 is preferable from a viewpoint of obtaining even better pressure resistance.

The first bending and the second bending result in formation of a layered structure I 97 and a layered structure II 98 at the tightly sealed section 94. In the layered structure I 97, the front surface film 2, the rear surface film 3, and the adhesive layer 5 are stacked in an order of adhesive layer/front surface film/rear surface film/rear surface film/front surface film/front surface film/rear surface film in a thickness direction of the packaging body 81, and in the layered structure II 98, the front surface film 2, the rear surface film 3, and the adhesive layer 5 are stacked in an order of adhesive layer/rear surface film/front surface film/front surface film/rear surface film in the thickness direction of the packaging body 81.

Moreover, in the layered structure I 97, the front surface film 2, the rear surface film 3, the adhesive layer 5, and the inner film 7 are stacked in an order of adhesive layer/front surface film/inner film/rear surface film/rear surface film/inner film/front surface film/front surface film/inner film/rear surface film, and in the layered structure II 98, the front surface film 2, the rear surface film 3, the adhesive layer 5, and the inner film 7 are stacked in an order of adhesive layer/rear surface film/inner film/front surface film/front surface film/inner film/rear surface film.

In the packaging body of the present embodiment, it is preferable that the layered structure I is positioned toward the second longitudinal direction end 91 side relative to the layered structure II.

FIG. 12D illustrates peeling of the release paper 63 from the seal 61. In the method of manufacturing a packaging body of the present embodiment or the use of a packaging bag of the present embodiment, it is preferable that an end section at a second bend section 96 side of the release paper 63 attached to the seal 61 is between the first bend section 95 and the second bend section 96 from a viewpoint of further facilitating sealing operation with the seal.

The length of the release paper 63 attached to the seal 61 is preferably not excessively long from a viewpoint that the adhesive surface 62 of the seal tends not to become attached to the front surface film 2 and an operation of peeling the release paper is simple. It is also preferable that in the packaging bag, the inner longitudinal direction end of the one part of the adhesive surface and the outer longitudinal direction end of the remaining part of the adhesive surface are within the previously described ranges.

FIG. 12E illustrates affixing of the seal 61 to the front surface film 2 such as to cover the layered structure I 97 and the layered structure II 98. In FIG. 12E, the seal 61 is affixed to the front surface film 2 such as to cover the first part of the adhesive layer 5 that is affixed to the front surface film 2 in the first bending and the second part of the adhesive layer 5 that is affixed to the rear surface film in the second bending. The seal 61 preferably covers the first bend section 95 and the second bend section 96.

FIG. 13 is a cross-sectional view illustrating a cross-section X-X of the packaging body in FIG. 1, illustrating an example of the packaging body of the present embodiment. At the closed section of the first longitudinal direction end of the packaging body illustrated in FIG. 13, the front surface film 2, the bottom surface film 41, and the rear surface film 3 are affixed through the front surface film/bottom surface film heat sealed section 163 and the rear surface film/bottom surface film heat sealed section 164. The packaging body 81 has a structure that, when contents 82 are placed therein, enables self-standing through opening out of the fold 42 of the bottom surface film 41.

The packaging body 81 illustrated in FIG. 13 includes the layered structure I 97 and the layered structure II 98 at the tightly sealed section 94. The layered structure I 97 is positioned toward a second longitudinal direction-end side relative to the layered structure II 98.

The packaging body illustrated in FIG. 13 holds contents 82. The contents in the packaging body of the present embodiment may, for example, be a primary container such as a plastic or glass container that holds an infectious substance such as blood, cells, biological experimental material, a clinical specimen, a trial specimen, urine, or hair, or a toxic substance such as bacteria, an insecticide or fungicide, a disinfectant, or a herbicide.

In the packaging body of the present embodiment, the radius of curvature of a bend part at which the front surface film 2 and the rear surface film 3 are folded (first bend section 95 and second bend section 96 in FIGS. 12A to 12E) is preferably 10 mm or less, and more preferably 8 mm or less. In this specification, the radius of curvature can be measured, for example, by observing a cross-section of the packaging body using a microscope.

The pressure resistance of the packaging body of the present embodiment as measured in accordance with UN regulations (UN3373 P650) is preferably 95 kPa or more.

The pressure resistance strength of the packaging body of the present embodiment at a temperature of 55° C. is preferably 95 kPa or more, and more preferably 100 kPa or more. The pressure resistance strength at a temperature of 55° C. can be measured by a method described in the subsequent EXAMPLES section.

The pressure resistance strength of the packaging body of the present embodiment at a temperature of −40° C. is preferably 95 kPa or more, and more preferably 100 kPa or more. The pressure resistance strength at a temperature of −40° C. can be measured by a method described in the subsequent EXAMPLES section.

It is preferable that the packaging body of the present embodiment does not allow leakage of liquid contained therein when the internal pressure of the packaging body is set at 100 kPa at a temperature of 55° C. or −40° C. Leakage of a liquid at the temperatures of 55° C. and −40° C. can be measured by a method described in the subsequent EXAMPLES section.

The packaging body of the present embodiment has excellent pressure resistance as a result of including specific layered structures at the tightly sealed section thereof and also including two bend sections. In particular, when the internal pressure of the packaging body increases, the bend sections at the first bend section 85 and the second bend section 86 tighten and the radius of curvature thereof decreases, which makes it difficult for pressure to leak out from the open section even at raised pressure.

Furthermore, in a situation in which the inner film 7 is provided, the bend sections tighten more readily and gaps at the bend sections are reduced, which further improves tight sealability of the tightly sealed section and pressure resistance. Moreover, it is advantageous to provide the inner film 7 in terms of safety because it becomes more difficult for contents to burst out even in the event of the seal of the packaging body breaking at raised pressure.

By forming the closed section at the first longitudinal direction-end side through sandwiching of a film that is folded at least once (for example, the bottom surface film 42 folded at the fold 42), the packaging body obtained after contents have been tightly sealed therein can be placed in a self-standing manner with the closed section at the first longitudinal direction-end side at the bottom of the packaging body. This restricts movement of contents inside the packaging body during transportation or the like, and makes it even harder for leakage of the contents to occur.

In the method of manufacturing a packaging body of the present embodiment and the use of a packaging bag of the present embodiment, the open section can be tightly sealed with ease without using a machine. Moreover, creases tend not to form during covering of the tightly sealed section with the seal.

Furthermore, in a case in which an inner longitudinal direction end of the one part of the adhesive surface of the seal is between a position at a distance of (2b-a)/4 in the longitudinal direction from the open section-side longitudinal direction end of the rear surface film and a position at a distance of (6b-a)/8 in the longitudinal direction from the open section-side longitudinal direction end, and an outer longitudinal direction end of the remaining part of the adhesive surface is between the open section-side longitudinal direction end of the rear surface film and the position at a distance of (2b -a)/4 in the longitudinal direction from the open section-side longitudinal direction end, it is easier for the adhesive surface and the front surface film to maintain a fixed distance after the second bending, sealing operation with the seal is easier, and creases are even less likely to form in a sealed section. As a result, even better pressure resistance can be obtained.

The packaging bag used in the packaging body of the present embodiment and the packaging bag of the present embodiment may be a packaging bag in which the front surface film and the rear surface film are affixed at the first longitudinal direction-end edge to form a closed section at the first longitudinal direction-end side without the bottom surface film therebetween.

The packaging body of the present embodiment can be suitably used as a secondary container for transportation of an infectious substance.

The use of a packaging bag of the present embodiment in a case in which the packaging bag illustrated in FIG. 6 is used preferably includes, with respect to the packaging bag illustrated in FIG. 6, bending the packaging bag 11 at the first position P1 and affixing the open section-side longitudinal direction end of the front surface film 2 to the first part of the adhesive layer 5 such that the first part M1a and the second part M1b of the first mark M1 compose the first mark M1, bending the packaging bag 11 at the second position P2 and affixing part of the rear surface film 3 to the second part of the adhesive layer 5 such that the first part M2a and the second part M2b of the second mark M2 compose the second mark M2, and affixing the remaining part of the adhesive surface 62 to the front surface film 2 such that the first part and the second part of the third mark compose the third mark and the seal 61 covers the first part and the second part of the adhesive layer 5.

Moreover, a method of manufacturing a packaging body of the present embodiment in a case in which the packaging bag illustrated in FIG. 6 is used preferably includes, with respect to the packaging bag illustrated in FIG. 6, bending the packaging bag 11 at the first position P1 and affixing the open section-side longitudinal direction end of the front surface film 2 to the first part of the adhesive layer 5 such that the first part M1a and the second part M1b of the first mark M1 compose the first mark M1, bending the packaging bag 11 at the second position P2 and affixing part of the rear surface film 3 to the second part of the adhesive layer 5 such that the first part M2a and the second part M2b of the second mark M2 compose the second mark M2, and affixing the remaining part of the adhesive surface 62 to the front surface film 2 such that the first part and the second part of the third mark compose the third mark and the seal 61 covers the first part and the second part of the adhesive layer 5.

The use of a packaging bag of the present embodiment or the method of manufacturing a packaging body of the present embodiment in a case in which the packaging bag illustrated in FIG. 6 is used is fundamentally the same as in a case in which the packaging bag illustrated in FIG. 2 is used, but in the first bending illustrated in FIG. 12B, the packaging bag 11 is bent at the first position P1 such that the first part M1a and the second part M1b of the divided first mark M1 are united to compose the first mark M1. The method by which the packaging bag is bent in the first bending may be folding (valley folding) at the first position P1 or may be curving of the packaging bag without folding at the first position P1.

Moreover, in the second bending illustrated in FIG. 12C, the packaging bag 11 is bent at the second position P2 and part of the divided rear surface film 3 is affixed to the second part of the adhesive layer 5 such that the first part M2a and the second part M2b of the divided second mark M2 are united to compose the second mark M2. The method by which the packaging bag is bent in the second bending may be folding at the second position P2 or may be curling of the packaging bag without folding at a bend section.

Furthermore, in affixing of the seal 61 to the front surface film 2 illustrated in FIG. 12E, the seal 61 is affixed to the front surface film 2 such that the first part M3a and the second part M3b of the divided third mark M3 are united to compose the third mark M3 and the seal 61 covers the layered structure I 97 and the layered structure II 98.

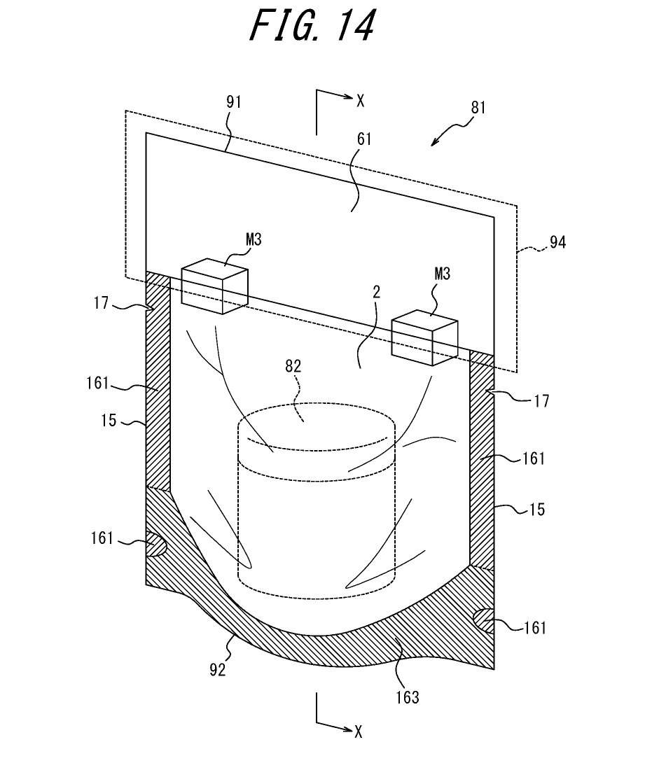

FIG. 14 is a schematic view (perspective view) illustrating an example of a packaging body manufactured by the method of manufacturing a packaging body described above using the packaging bag illustrated in FIG. 6.

### EXAMPLES

The following provides a more detailed description of this disclosure based on examples, but this disclosure is not limited by the following examples.

### Example 1

A laminated film of 122 μm in thickness that was obtained through dry lamination using polyethylene terephthalate as a substrate layer, a polyamide biaxially stretched film as an intermediate layer, and linear low-density polyethylene (LLDPE) as a heat sealing layer was used as each of a front surface film, a rear surface film, and a bottom surface film. The front surface film and the rear surface film were rectangular films of 120 mm in width and 220 mm in length. The bottom surface film was a rectangular film of 120 mm in width and 62 mm in length. The bottom surface film was used folded in two with a position half way along a length direction thereof as a fold. A linear low-density polyethylene (LLDPE) single layer film of 120 mm in width, 60 mm in length, and 60 μm in thickness was used as an inner film.

Edges at both width direction ends of the front surface film, the inner film, and the rear surface film were overlapped in this order such that both width direction ends and edges at a second longitudinal direction end overlapped, and a section 10 mm from each of the width direction-end edges was heat sealed. Edges at the second longitudinal direction-end of the rear surface film and the inner film were heat sealed at a section 10 mm from the end edge.

Edges at the first longitudinal direction end of the front surface film, the bottom surface film, and the rear surface film were overlapped in this order such that both width direction ends and the edges at the first longitudinal direction end overlapped and such that the heat sealing layers faced one another, and were heat sealed. As illustrated in FIG. 2, the front surface film and the rear surface film were heat sealed at one part at both width direction ends within a front surface film/bottom surface film heat sealed section, whereas the front surface film and bottom surface film, and the rear surface film and bottom surface film were heat sealed at a remaining part of each of the width direction ends and also at the first longitudinal direction-end edge. Note that at the front surface film/rear surface film heat sealed section present at one part of both width direction ends within the front surface film/bottom surface film heat sealed section, a section of the bottom surface film was cut away in the shape of the front surface film/rear surface film heat sealed section such that the front surface film and the rear surface film were directly affixed to each other at the front surface film/rear surface film heat sealed section. When viewed from the front surface film side, the bottom surface film/front surface film heat sealed section and the bottom surface film/rear surface film heat sealed section were arc-shaped as illustrated in FIGS. 3 and 4. Note that heat sealing was performed for at least 10 mm from the edge at both width direction ends. As a result, a closed section was formed at both width direction-end edges and the first longitudinal direction-end edge, and an open section was formed at the second longitudinal direction-end side.

Next, an adhesive layer of 120 mm in width and 25 mm in length was provided at a packaging bag outer side of the front surface film between a position 50 mm from the open section-side longitudinal direction end and a position 75 mm from the open section-side longitudinal direction end. An acrylic-based adhesive layer was used as the adhesive layer.

Next, a seal was prepared by affixing release paper of 116 mm in width and 30 mm in length to an adhesive surface of a seal of 116 mm in width and 65 mm in length, on a part of the adhesive surface from one length direction end to a position 30 mm from the one length direction end. An acrylic-based adhesive was used as an adhesive for forming the adhesive surface. The rear surface film and the seal were affixed from a position 10 mm from the open section-side longitudinal direction end of the rear surface film to a position 75 mm from the open section-side longitudinal direction end of the rear surface film such that the part of the seal to which the release paper was affixed was positioned at the open section side. Note that the release paper was affixed with a blank section 2 mm from each width direction end of the rear surface film. In this manner, a packaging bag was obtained.

The obtained packaging bag was bent in the longitudinal direction at a position 30 mm from the open section-side longitudinal direction end of the packaging bag, and the open section-side longitudinal direction end of the front surface film was affixed to the adhesive layer (first bending). The longitudinal direction length of the part at which the front surface film and the adhesive layer were affixed to each other was 10 mm.

Next, the packaging bag was further bent in the longitudinal direction at a position 50 mm from the open section-side longitudinal direction end of the packaging bag, and the rear surface film was affixed to the adhesive layer (second bending). In this manner, a tightly sealed section was formed that included a layered structure I stacked in an order of adhesive layer/front surface film/inner film/rear surface film/rear surface film/inner film/front surface film/front surface film/inner film/rear surface film between an open section-side longitudinal direction end of the adhesive layer and a position 10 mm from the open section-side longitudinal direction end of the adhesive layer, and a layered structure II stacked in an order of adhesive layer/rear surface film/inner film/front surface film/front surface film/inner film/rear surface film between the position 10 mm from the open section-side longitudinal direction end of the adhesive layer and a position 20 mm from the open section-side longitudinal direction end of the adhesive layer.

Next, the release paper of the seal was peeled off, and the adhesive surface of the seal and the front surface film were affixed to each other such that the layered structure I and the layered structure II were covered to tightly seal the packaging bag. In this manner, a packaging body was obtained.

Table 1 indicates the dimensions of the packaging body and bending positions in tight sealing of the open section of the packaging bag (refer to FIG. 15). In Table 1 and FIGS. 15A and 15B, “A” is the width direction length of the packaging bag. “B” is the length from an open section-side longitudinal direction end of the packaging bag to a position bent in accompaniment to second bending. “C” is the length from the position bent in accompaniment to second bending to a position of bending in first bending (first bend section). “D” is the length from the position of bending in first bending (first bend section) to a position of bending in second bending (second bend section). “E” is the length from the position of bending in second bending (second bend section) to a closed section-side longitudinal direction end of the inner film. “F” is the length from the open section-side longitudinal direction end of the packaging bag to the position of bending in first bending (first bend section). “G” is the length from the open section-side longitudinal direction end of the packaging bag to the position of bending in second- bending (second bend section). “H” is the length from the open section-side longitudinal direction end of the packaging bag to a closed section-side longitudinal direction end of the inner film. “I” is the length from the open section-side longitudinal direction end of the packaging bag to an open section-side longitudinal direction end of the adhesive layer. “J” is the length from the open section-side longitudinal direction end of the packaging bag to a closed section-side longitudinal direction end of the adhesive layer. “K” is the longitudinal direction length of the packaging bag. “L” is the length from the open section-side longitudinal direction end of the packaging bag to an open section-side longitudinal direction end of the seal. “M” is the length from the open section-side longitudinal direction end of the packaging bag to a closed section-side longitudinal direction end of the seal. “N” is the width direction length of the seal. “O” is the length from a width direction end of the packaging bag to a width direction end of the seal. “P” is the length from the open section-side longitudinal direction end of the packaging bag to a closed section-side longitudinal direction end of the release paper affixed to the adhesive surface of the seal.

### Examples 2, 3, and 5 to 8, and Comparative Examples 1 to 3

A packaging body was obtained in the same way as in Example 1 with the exception that the dimensions of the front surface film, the rear surface film, the inner film, the adhesive layer, and the seal, and the bending positions were changed as indicated in Table 1.

### Examples 4 and 9

A packaging body was obtained in the same way as in Example 1 with the exception that: a laminated film of 193 μm in thickness that was obtained by dry lamination using polyethylene terephthalate as a substrate layer, a polyamide biaxially stretched film as an intermediate layer, and linear low-density polyethylene (LLDPE) as a heat sealing layer was used for each of the front surface film, the rear surface film, and the bottom surface film; a rectangular film of 300 mm in width and 148 mm in length that was used folded in two with a position half way along the length direction as a fold was used as the bottom surface film; a linear low-density polyethylene (LLDPE) single layer film of 100 μm in thickness was used as the inner film; and the dimensions of the front surface film, the rear surface film, the inner film, the adhesive layer, and the seal, and the bending positions were changed as indicated in Table 1.

### Evaluation

The packaging bodies obtained in the examples and comparative examples were measured as follows.

(Pressure Resistance)

UN regulation pressure resistance was evaluated in accordance with UN regulations (UN3373 P650). An evaluation of “good” (good pressure resistance) was given in a case in which the packaging bag did not rupture even at 95 kPa and an evaluation of “poor” (poor pressure resistance) was given in a case in which the packaging bag ruptured.

Adhesive tape was used to secure a rubber sheet of approximately 1 mm in thickness to a part of the front surface film at the outer side of the packaging bag that did not overlap with the inner film of the packaging bag.

Under temperature conditions of both 55° C. and −40° C., an injection needle connected to an air compressor was used to pierce the rubber sheet on the front surface film and inject air into the packaging bag at a rate of 1 L/minute until the packaging bag ruptured. The pressure at which the packaging bag ruptured was measured, and the measured pressure was taken to be the pressure resistance strength (kPa) at the corresponding temperature. Higher pressure resistance strength indicates that a packaging body has better pressure resistance.

(Leak Resistance)

Leak resistance was evaluated for packaging bodies that did not rupture even at 100 kPa in measurement of pressure resistance strength described above. Specifically, a dye penetration inspection material (product name: Color Check® Penetrant FR-S (Color Check is a registered trademark in Japan, other countries, or both); produced by Taseto Co., Ltd.) was placed inside a packaging bag and the packaging bag was tightly sealed in the same way as described above to prepare a packaging body. Under temperature conditions of both 55° C. and −40° C., an air compressor was used to pump air into the packaging body to reach a pressure of 100 kPa. The presence of leaks was checked by eye and was not observed for any of the packaging bodies for which this evaluation was performed.

(Ease of Tight Sealing)

Eleven people were requested to tightly seal the packaging bags described in the examples and comparative examples. The ease of tight sealing was then evaluated by checking the tightly sealed section of each of the packaging bags by eye after packaging and counting the number of packaging bodies for which creases were formed at the tightly sealed section. An evaluation of “good” (easy to tightly seal) was given in a case in which creases were not formed at the tightly sealed section of any of the packaging bodies and an evaluation of “poor” (difficult to tightly seal) was given in a case in which creases were formed in one or more of the packaging bodies.

(Overall Evaluation)

An evaluation of “good” (excellent pressure resistance and open section can be tightly sealed with ease) was given for a packaging body that had good UN regulation pressure resistance, had pressure resistance strength of 100 kPa or more, and was easy to tightly seal, and an evaluation of “poor” (poor pressure resistance or open section cannot be tightly sealed with ease) was given for a packaging body having poor UN regulation pressure resistance or ease of tight sealing, or having a pressure resistance strength of less than 100 kPa.

TABLE 1

| | | | | Example 1 | Example 2 | Example 3 | Example 4 | Example 5 | Example 6 | Example 7 |
|---|---|---|---|---|---|---|---|---|---|---|
| Dimensions | A | | mm | 120 | 120 | 120 | 300 | 120 | 120 | 120 |
| of | B | | mm | 10 | 12 | 10 | 12 | 10 | 10 | 10 |
| packaging | C | | mm | 20 | 24 | 35 | 38 | 25 | 25 | 25 |
| bag and | D | | mm | 20 | 24 | 35 | 38 | 25 | 25 | 25 |
| bend | E | | mm | 10 | 10 | 10 | 10 | 10 | 10 | 10 |
| section | F | | mm | 30 | 36 | 45 | 50 | 35 | 35 | 35 |
| positions | G | | mm | 50 | 60 | 80 | 88 | 60 | 60 | 60 |
| | H | | mm | 60 | 70 | 90 | 98 | 70 | 70 | 70 |
| | I | | mm | 50 | 60 | 80 | 88 | 60 | 60 | 60 |
| | J | | mm | 75 | 85 | 105 | 113 | 85 | 85 | 85 |
| | K | | mm | 220 | 250 | 220 | 500 | 250 | 250 | 250 |
| | L | | mm | 10 | 10 | 10 | 20 | 5 | 10 | 10 |
| | M | | mm | 75 | 85 | 105 | 113 | 75 | 110 | 85 |
| | N | | mm | 116 | 116 | 116 | 300 | 116 | 116 | 116 |
| | O | | mm | 2 | 2 | 2 | 0 | 2 | 2 | 2 |
| | P | | mm | 40 | 50 | 50 | 60 | 50 | 50 | 55 |
| Evaluation | Pressure | UN regulation pressure | — | Good | Good | Good | Good | Good | Good | Good |
| | resistance | resistance | | | | | | | | |
| | | Pressure resistance | kPa | 140 | 135 | 110 | 140 | 110 | 130 | 140 |
| | | strength (55° C.) | | | | | | | | |
| | | Pressure resistance | kPa | 130 | 130 | 100 | 140 | 120 | 140 | 130 |
| | | strength (−40° C.) | | | | | | | | |
| | | Leak resistance (55° C.) | — | Good | Good | Good | Good | Good | Good | Good |
| | | Leak resistance (−40° C.) | — | Good | Good | Good | Good | Good | Good | Good |

| | | | | | | | | |
|---|---|---|---|---|---|---|---|---|
| Ease of tight sealing | — | Good | Good | Good | Good | Good | Good | Good |
| Overall evaluation | — | Good | Good | Good | Good | Good | Good | Good |

| | | | | | | Comparative | Comparative | Comparative |
|---|---|---|---|---|---|---|---|---|
| | | | | Example 8 | Example 9 | Example 1 | Example 2 | Example 3 |
| Dimensions | A | | mm | 120 | 300 | 120 | 120 | 120 |
| of | B | | mm | 12 | 24 | 5 | 10 | 10 |
| packaging | C | | mm | 24 | 48 | 5 | 25 | 25 |
| bag and | D | | mm | 24 | 48 | 5 | 25 | 25 |
| bend | E | | mm | 15 | 80 | 20 | 10 | 10 |
| section | F | | mm | 36 | 72 | 10 | 35 | 35 |
| positions | G | | mm | 60 | 120 | 15 | 60 | 60 |
| | H | | mm | 70 | 200 | 35 | 70 | 50 |
| | I | | mm | 60 | 120 | 15 | 60 | 60 |
| | J | | mm | 85 | 170 | 35 | 65 | 70 |
| | K | | mm | 250 | 550 | 220 | 250 | 250 |
| | L | | mm | 5 | 20 | 2 | 10 | 10 |
| | M | | mm | 80 | 140 | 55 | 85 | 85 |
| | N | | mm | 116 | 296 | 116 | 116 | 116 |
| | O | | mm | 2 | 2 | 2 | 2 | 2 |
| | P | | mm | 50 | 100 | 12 | 50 | 50 |
| Evaluation | Pressure | UN regulation pressure | — | Good | Good | Poor | Poor | Poor |
| | resistance | resistance | | | | | | |
| | | Pressure resistance | kPa | 140 | 140 | 60 | 30 | 70 |
| | | strength (55° C.) | | | | | | |
| | | Pressure resistance | kPa | 130 | 130 | 70 | 20 | 50 |
| | | strength (−40° C.) | | | | | | |
| | | Leak resistance (55° C.) | — | Good | Good | — | — | — |
| | | Leak resistance (−40° C.) | — | Good | Good | — | — | — |

| | | | | | | |
|---|---|---|---|---|---|---|
| Ease of tight sealing | — | Good | Good | Good | Good | Good |
| Overall evaluation | — | Good | Good | Poor | Poor | Poor |

As indicated in Table 1, the packaging bodies of Examples 1 to 9 had excellent pressure resistance. Moreover, in these packaging bodies, the open section could be tightly sealed with ease. On the other hand, in the case of the packaging bodies of Comparative Examples 1 to 3, it was not possible to affix the rear surface film and the adhesive layer to each other in the second bending, and adequate pressure resistance was not obtained.

### REFERENCE SIGNS LIST

11 packaging bag

12 open section

13 open section-side longitudinal direction end

14 closed section-side longitudinal direction end

15 width direction end

161 front surface film/rear surface film heat sealed section

162 front surface film/rear surface film/inner film heat sealed section

163 front surface film/bottom surface film heat sealed section

164 rear surface film/bottom surface film heat sealed section

17 notch

2 front surface film

3 rear surface film

41 bottom surface film

42 fold

5 adhesive layer

61 seal

62 adhesive surface

63 release paper

7 inner film

81 packaging body

82 contents

91 second longitudinal direction end

92 first longitudinal direction end

93 closed section

94 tightly sealed section

95 first bend section

96 second bend section

97 layered structure I

98 layered structure II

De longitudinal direction

Dw width direction

M1 first mark

M1a first part of first mark

M1b second part of first mark

M2 second mark

M2a first part of second mark

M2b second part of second mark

M3 third mark

M3a first part of third mark

M3b second part of third mark

P1 first position of front surface film in longitudinal direction

P2 second position of rear surface film in longitudinal direction

P3 third position of front surface film in longitudinal direction

1. A packaging body comprising at least a front surface film, a rear surface film, an adhesive layer on the front surface film, and a seal on the rear surface film, wherein
the front surface film and the rear surface film are affixed to each other at both width direction-end edges and at a first longitudinal direction-end edge to form a closed section at a first longitudinal direction-end side, and part of the front surface film and part of the rear surface film are affixed to the adhesive layer to form a tightly sealed section at a second longitudinal direction-end side,
at the tightly sealed section, the packaging body includes at least a layered structure I in which the front surface film, the rear surface film, and the adhesive layer are stacked in an order of adhesive layer/front surface film/rear surface film/rear surface film/front surface film/front surface film/rear surface film in a packaging body thickness direction, and a layered structure II in which the front surface film, the rear surface film, and the adhesive layer are stacked in an order of adhesive layer/rear surface film/front surface film/front surface film/rear surface film in the packaging body thickness direction, and
the layered structure I and the layered structure II are covered by the seal.

2. The packaging body according to claim 1, wherein
the layered structure I is positioned toward the second longitudinal direction-end side relative to the layered structure II.

3. The packaging body according to claim 1, further comprising
an inner film between the front surface film and the rear surface film, wherein
the inner film is sandwiched between the front surface film and the rear surface film and is affixed to the front surface film and the rear surface film at both width direction-end edges,
the layered structure I is a layered structure stacked in an order of adhesive layer/front surface film/inner film/rear surface film/rear surface film/inner film/front surface film/front surface film/inner film/rear surface film, and
the layered structure II is a layered structure stacked in an order of adhesive layer/rear surface film/inner film/front surface film/front surface film/inner film/rear surface film.

4. The packaging body according to claim 1, wherein
at the tightly sealed section, a bend portion at which the front surface film and the rear surface film are folded has a radius of curvature of 10 mm or less.

5. The packaging body according to claim 1, wherein
the front surface film and the rear surface film are affixed to each other via a bottom surface film at a first longitudinal direction end.

6. A method of manufacturing a packaging body comprising,
with respect to a packaging bag in which
a front surface film and a rear surface film are affixed to each other at both width direction-end edges and at a first longitudinal direction-end edge to form a closed section at a first longitudinal direction-end side and an open section at a second longitudinal direction-end side,
an adhesive layer of the same width as the front surface film is disposed at a packaging bag outer side of the front surface film,
a seal having an adhesive surface as at least one surface thereof is disposed at a packaging bag outer side of the rear surface film, and
one part of the adhesive surface is attached to the rear surface film and a remaining part of the adhesive surface is attached to release paper:
bending the packaging bag in a longitudinal direction and affixing an open section-side longitudinal direction end of the front surface film to a first part of the adhesive layer;
further bending the packaging bag in the longitudinal direction and affixing part of the rear surface film to a second part of the adhesive layer; and
affixing the remaining part of the adhesive surface to the front surface film such that the seal covers the first part and the second part of the adhesive layer.

7. A use of a packaging bag comprising,
with respect to a packaging bag in which
a front surface film and a rear surface film are affixed to each other at both width direction-end edges and at a first longitudinal direction-end edge to form a closed section at a first longitudinal direction-end side and an open section at a second longitudinal direction-end side,
an adhesive layer of the same width as the front surface film is disposed at a packaging bag outer side of the front surface film,
a seal having an adhesive surface as at least one surface thereof is disposed at a packaging bag outer side of the rear surface film, and
one part of the adhesive surface is attached to the rear surface film and a remaining part of the adhesive surface is attached to release paper:
bending the packaging bag in a longitudinal direction and affixing an open section-side longitudinal direction end of the front surface film to a first part of the adhesive layer;
further bending the packaging bag in the longitudinal direction and affixing part of the rear surface film to a second part of the adhesive layer; and
affixing the remaining part of the adhesive surface to the front surface film such that the seal covers the first part and the second part of the adhesive layer.

8. A packaging bag comprising:
a front surface film and a rear surface film that are affixed to each other at both width direction-end edges and at a first longitudinal direction-end edge to form a closed section at a first longitudinal direction-end side and an open section at a second longitudinal direction-end side;
an adhesive layer of the same width as the front surface film that is disposed at a packaging bag outer side of the front surface film; and
a seal having an adhesive surface as at least one surface thereof that is disposed at a packaging bag outer side of the rear surface film, wherein
one part of the adhesive surface is attached to the rear surface film and a remaining part of the adhesive surface is attached to release paper, and
when a longitudinal direction length of the adhesive layer is taken to be “a” and a longitudinal direction length from an open section-side longitudinal direction end of the front surface film to a closed section-side longitudinal direction end of the adhesive layer is taken to be “b”:
an inner longitudinal direction end of the one part of the adhesive surface is between a position at a distance of (2b -a)/4 in a longitudinal direction from an open section-side longitudinal direction end of the rear surface film and a position at a distance of (6b a)/8 in the longitudinal direction from the open section-side longitudinal direction end of the rear surface film; and
an outer longitudinal direction end of the remaining part of the adhesive surface is between the open section-side longitudinal direction end of the rear surface film and the position at a distance of (2b-a)/4 in the longitudinal direction from the open section-side longitudinal direction end of the rear surface film.

9. The packaging bag according to claim 8, wherein
“a” as a proportion relative to “b”, calculated by (a/b)×100, is 15% to 50%.

10. The packaging bag according to claim 8, further comprising
an inner film between the front surface film and the rear surface film, wherein
a longitudinal directional length of the inner film is short compared to a longitudinal direction length of the front surface film and the rear surface film,
a width direction length of the inner film is the same as a width direction length of the front surface film and the rear surface film,
the inner film is affixed to an open section-side longitudinal direction-end edge of the front surface film or the rear surface film at an open section-side longitudinal direction-end edge of the packaging bag, and
the inner film is sandwiched between and affixed to the front surface film and the rear surface film at both width direction-end edges of the packaging bag.

11. The packaging bag according to claim 10, wherein
the longitudinal direction length of the inner film is longer than a longitudinal direction length from the open section-side longitudinal direction end of the front surface film or the rear surface film to an open section-side longitudinal direction end of the adhesive layer.

12. The packaging bag according to claim 8, wherein
the front surface film and the rear surface film are affixed to each other via a bottom surface film at a first longitudinal direction end.

13. The packaging bag according to claim 8, further comprising:
at least one first mark including a first part and a second part, wherein the first part of the first mark is disposed along the open section-side longitudinal direction end of the rear surface film and the second part of the first mark is disposed at a part of the front surface film on which the adhesive layer is disposed such that the first part and the second part of the first mark become positioned to compose the first mark when the packaging bag is bent at a first position located further to an open section side than an open section-side longitudinal direction end of the adhesive layer, and the open section-side longitudinal direction end of the front surface film is affixed to a first part of the adhesive layer;
at least one second mark including a first part and a second part, wherein the first part of the second mark is disposed along the open section-side longitudinal direction end of the front surface film at an open section side of the first position of the front surface film or the rear surface film, and the second part of the second mark is disposed along the closed section-side longitudinal direction end of the adhesive layer at a closed section side thereof at the front surface film or the rear surface film such that the first part and the second part of the second mark become positioned to compose the second mark when the packaging bag is bent at the first position and the open section-side longitudinal direction end of the front surface film is affixed to the first part of the adhesive layer, and subsequently the packaging bag is bent at a second position of the rear surface film that is located further to the open section side than the first position and part of the rear surface film is affixed to a second part of the adhesive layer; and
at least one third mark including a first part and a second part, wherein the first part of the third mark is disposed along an outer longitudinal direction end of the seal at an opposite surface to the adhesive surface and the second part of the third mark is disposed along the open section-side longitudinal direction end of the front surface film at a closed section side of a third position of the front surface film that is located further to a longitudinal direction closed section side of the front surface film than the adhesive layer such that the first part and the second part of the third mark become positioned to compose the third mark when the packaging bag is bent at the first position and the open section-side longitudinal direction end of the front surface film is affixed to the first part of the adhesive layer, the packaging bag is then bent at the second position and part of the rear surface film is affixed to the second part of the adhesive layer, and subsequently the remaining part of the adhesive surface is affixed to the front surface film such that the seal covers the first part and the second part of the adhesive layer.

14. The packaging bag according to claim 13, wherein
the first mark, the second mark, and the third mark differ from one another in terms of either or both of color and shape.

15. The packaging bag according to claim 13, further comprising
a first bending line disposed along the open section-side longitudinal direction end of the front surface film at the first position of the front surface film and a second bending line disposed along the open section-side longitudinal direction end of the rear surface film at the second position of the rear surface film.

16. A use of a packaging bag comprising, with respect to the packaging bag according to claim 13:
bending the packaging bag at the first position and affixing the open section-side longitudinal direction end of the front surface film to the first part of the adhesive layer such that the first part and the second part of the first mark compose the first mark;
bending the packaging bag at the second position and affixing part of the rear surface film to the second part of the adhesive layer such that the first part and the second part of the second mark compose the second mark; and
affixing the remaining part of the adhesive surface to the front surface film such that the first part and the second part of the third mark compose the third mark, and such that the seal covers the first part and the second part of the adhesive layer.

17. A method of manufacturing a packaging body comprising, with respect to the packaging bag according to claim 13:
bending the packaging bag at the first position and affixing the open section-side longitudinal direction end of the front surface film to the first part of the adhesive layer such that the first part and the second part of the first mark compose the first mark;
bending the packaging bag at the second position and affixing part of the rear surface film to the second part of the adhesive layer such that the first part and the second part of the second mark compose the second mark; and
affixing the remaining part of the adhesive surface to the front surface film such that the first part and the second part of the third mark compose the third mark, and such that the seal covers the first part and the second part of the adhesive layer.
